(19) United States
(12) Patent Application Publication
(10) Pub. No.: US 2024/0402624 A1
(43) Pub. Date: Dec. 5, 2024

(54) IMAGE FORMING APPARATUS

(71) Applicant: KYOCERA Document Solutions Inc., Osaka (JP)

(72) Inventors: Yuko IWASHITA, Osaka-shi (JP); Yasuhiro OISHI, Osaka-shi (JP)

(73) Assignee: KYOCERA Document Solutions Inc., Osaka (JP)

(21) Appl. No.: 18/676,173

(22) Filed: May 28, 2024

(30) Foreign Application Priority Data
May 30, 2023 (JP) 2023-088962

(51) Int. Cl. G03G 5/14; G03G 21/00

(52) U.S. Cl. CPC G03G 5/144; G03G 21/0047; G03G 21/0058

(57) ABSTRACT

An image forming apparatus includes an image bearing member, a charger that charges the surface of the image bearing member to positive polarity, a light exposure device that exposes the charged surface of the image bearing member to light to form an electrostatic latent image on the surface of the image bearing member, a development device that develops the electrostatic latent image into a toner image, a transfer device that transfers the toner image from the image bearing member to a transfer target, a cleaning member that collects toner attached to the surface of the image bearing member by contacting the surface of the image bearing member, and a controller that controls voltage to be applied to the cleaning member. The controller causes a first voltage with negative polarity to be applied to the cleaning member in a printing mode.

### INCORPORATION BY REFERENCE

The present application claims priority under 35 U.S.C. § 119 to Japanese Patent Application No. 2023-088962, filed on May 30, 2023. The contents of this application are incorporated herein by reference in their entirety.

### BACKGROUND

The present disclosure relates to an image forming apparatus.

Image forming apparatuses are required to be able to form images with less fog even in high-temperature and high-humidity environments. Also, the image forming apparatuses are required to have an electrophotographic photosensitive member used as an image bearing member that can maintain a certain level of sensitivity irrespective of the environment.

The image forming apparatuses may include a cleaning member for cleaning the electrophotographic photosensitive member by electrostatic force. An image forming apparatus including the above cleaning member is advantageous for example in realizing extended lifetime of the electrophotographic photosensitive member compared to typical image forming apparatuses that physically cleans the electrophotographic photosensitive member using a cleaning blade. However, in cleaning the electrophotographic photosensitive member by electrostatic force, charging (e.g., charging to positive polarity) by a charger and charging (e.g., charging to negative polarity) by the cleaning member are repeated, leading to insufficient charging by the charger (tending to cause charge potential decrease).

To tackle the above problem, an electrophotographic photosensitive member is proposed for example that includes an intermediate layer with a given physical property that contains metal oxide particles. The intermediate layer plays the role of increasing adhesion between a conductive substrate and a photosensitive layer and inhibiting charge injection from the conductive substrate side to the photosensitive layer side.

### SUMMARY

An image forming apparatus according to an aspect of the present disclosure includes an image bearing member, a charger that charges a surface of the image bearing member to positive polarity, a light exposure device that exposes the charged surface of the image bearing member to light to form an electrostatic latent image on the surface of the image bearing member, a development device that develops the electrostatic latent image into a toner image, a transfer device that transfers the toner image from the image bearing member to a transfer target, a cleaning member that collects toner attached to the surface of the image bearing member by contacting the surface of the image bearing member, and a controller that controls voltage to be applied to the cleaning member. The controller causes a first voltage with negative polarity to be applied to the cleaning member in a printing mode. The image bearing member is an electrophotographic photosensitive member including a conductive substrate, an intermediate layer provided on the conductive substrate, and a photosensitive layer provided on the intermediate layer. The intermediate layer contains a specific polyamide resin and specific inorganic particles. The specific inorganic particles include metal oxide particles. The specific polyamide resin includes a first repeating unit derived from an aliphatic dicarboxylic acid and a second repeating unit derived from a diamine compound. A total percentage content of the first repeating unit and the second repeating unit is at least 80% by mole to all repeating units included in the specific polyamide resin.

### BRIEF DESCRIPTION OF THE DRAWINGS

FIG. 1 is a partial cross-sectional view of an example of an electrophotographic photosensitive member according to the present disclosure.

FIG. 2 is a cross-sectional view of an example of an image forming apparatus according to the present disclosure.

FIG. 3 is a diagram illustrating an image bearing member and a cleaning member illustrated in FIG. 2 and a controller.

FIG. 4 is a time chart depicting control of the cleaning member in a printing mode and a cleaning mode.

FIG. 5 is a flowchart depicting control of the image forming apparatus illustrated in FIG. 2.

### DETAILED DESCRIPTION

The following describes embodiments of the present disclosure in detail. However, the present disclosure is not limited to the following embodiments and can be practiced with appropriate alteration added within the scope of the purpose of the present disclosure.

The term “(meth)acryl” may be used as a generic term for both acryl and methacryl. The term “(meth)acrylate” is used as a generic term for both acrylate and methacrylate. Unless otherwise stated, the number average particle diameter of a powder is a number average value of equivalent circle diameters (Heywood diameters: diameters of circles having the same areas as projected areas of the primary particles) of primary particles of the powder as measured using a scanning electron microscope. The number average primary particle diameter of a powder is a number average value of equivalent circle diameters of 100 primary particles of the powder, for example. In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof. The term “formula” is used collectively for both “general formulas” and “chemical formulas”. The phrase “each represent, independently of one another,” in description about formulas means possibly representing the same group or different groups. Unless otherwise stated, one type of each component described in the present specification may be used independently, or two or more types of the component may be used in combination. For example, the phrases “at least one of A, B, and C” and “any of A, B, and C” are the same as the phrase “at least one selected from the group consisting of A, B, and C”.

### [Image Forming Apparatus]

An embodiment of the present disclosure relates to an image forming apparatus. The image forming apparatus of the present embodiment includes an image bearing member, a charger that charges the surface of the image bearing member to positive polarity, a light exposure device that exposes the charged surface of the image bearing member to light to form an electrostatic latent image on the surface of the image bearing member, a development device that develops the electrostatic latent image into a toner image, a transfer device that transfers the toner image from the image bearing member to a transfer target, a cleaning member that collects toner attached to the surface of the image bearing member by contacting the surface of the image bearing member, and a controller that controls voltage to be applied to the cleaning member. The controller causes a first voltage with negative polarity to be applied to the cleaning member in a printing mode. The image bearing member is an electrophotographic photosensitive member (also referred to below as a photosensitive member) including a conductive substrate, an intermediate layer provided on the conductive substrate, and a photosensitive layer provided on the intermediate layer. The intermediate layer contains a specific polyamide resin and specific inorganic particles. The specific inorganic particles include metal oxide particles. The specific polyamide resin includes a first repeating unit derived from an aliphatic dicarboxylic acid and a second repeating unit derived from a diamine compound. The total percentage content of the first repeating unit and the second repeating unit is at least 80% by mole to all repeating units included in the specific polyamide resin.

The image forming apparatus of the present embodiment includes a cleaning member that cleans the photosensitive member by electrostatic force as stated above. As a result of having the above configuration, the image forming apparatus of the present embodiment, which includes a cleaning member that cleans the electrophotographic photosensitive member by electrostatic force though, can inhibit charge potential decrease of the photosensitive member, can have reduced environmental dependence of sensitivity of the photosensitive member, and can inhibit occurrence of fogging in high-temperature and high-humidity environments. The reasons therefor are inferred as follows. The photosensitive member included in the image forming apparatus of the present embodiment includes an intermediate layer. The intermediate layer exhibits a function of not inhibiting flow of electric current generated during light exposure of the photosensitive member while exhibiting voltage resistance to the extent that current leakage does not occur. This can enable the intermediate layer to stabilize sensitivity of the photosensitive member (particularly, sensitivity in low-temperature and low-humidity environments) to inhibit sensitivity of the photosensitive member from increasing and decreasing dependent on the environment. Furthermore, the intermediate layer of the photosensitive member can inhibit charge accumulation in the photosensitive layer. As a result, the image forming apparatus of the present embodiment can inhibit the charge potential decrease of the photosensitive member even when charging to positive polarity by the charger and charging to negative polarity by the cleaning member on the photosensitive member are repeated. In other words, by providing the intermediate layer, the image forming apparatus of the present embodiment can avoid a demerit (e.g., charge potential decrease of the photosensitive member) while bringing a merit (e.g., extension of lifetime of the photosensitive member) obtained by cleaning the photosensitive member by electrostatic force. Furthermore, an intermediate layer of known photosensitive members decreases in resistance due to moisture absorption in high-temperature and high-humidity environments, tending to cause current leakage. As a result, the intermediate layer of known photosensitive members may not sufficiently exhibit their function in high-temperature and high-humidity environments. By contrast, the intermediate layer included in the image forming apparatus of the present embodiment contains the specific polyamide resin and the specific inorganic particles. The specific polyamide resin and the specific inorganic particles inhibit moisture absorption of the intermediate layer in high-temperature and high-humidity environments and tend to allow the intermediate layer to exhibit the aforementioned function. The polyamide resin can be produced only with a diamine and a dicarboxylic acid as a typical feature thereof, enabling achievement of stable quality. Therefore, the image forming apparatus of the present embodiment can inhibit occurrence of fogging in high-temperature and high-humidity environments. The photosensitive member included in the image forming apparatus of the present embodiment is described first in detail, followed by description of the configurations of elements other than the photosensitive member.

### [Photosensitive Member]

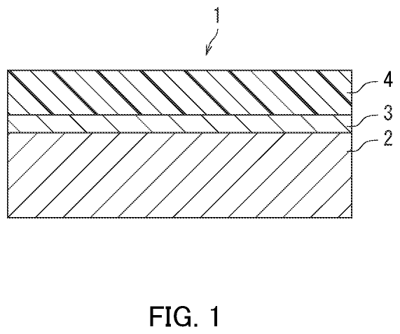

The photosensitive member is a single-layer electrophotographic photosensitive member (also referred to below as a single-layer photosensitive member), for example. The structure of a photosensitive member 1, which is an example of the photosensitive member included in the image forming apparatus of the present embodiment, is described below with reference to FIG. 1. FIG. 1 is a partial cross-sectional view of the photosensitive member 1. As illustrated in FIG. 1, the photosensitive member 1 includes a conductive substrate 2, an intermediate layer 3 provided on the conductive substrate 2, and a photosensitive layer 4 provided on the intermediate layer 3, for example. The photosensitive layer 4 is a photosensitive layer of a single layer (also referred to below as a single-layer photosensitive layer).

The intermediate layer 3 has a thickness of preferably at least 1 μm and no greater than 20 μm, and more preferably at least 1 μm and no greater than 10 μm.

The thickness of the photosensitive layer 4 is not limited particularly and is preferably at least 5 μm and no greater than 100 μm, and more preferably at least 10 μm and no greater than 50 μm. The structure of the photosensitive member 1 being an example of the photosensitive member has been described so far with reference to FIG. 1.

However, the structure of the photosensitive member may differ from that illustrated in FIG. 1. For example, the photosensitive member may further include another layer (e.g., a protective layer provided on the photosensitive layer) in addition to the conductive substrate, the intermediate layer, and the photosensitive layer. Alternatively or additionally, the photosensitive member may include a photosensitive layer of multiple layers (also referred to below as multilayer photosensitive layer).

### [Intermediate Layer]

The intermediate layer contains a specific polyamide resin and specific organic particles. Presence of the intermediate layer can allow smooth flow of electric current generated during light exposure of the photosensitive member while maintaining the insulation state to the extent that occurrence of current leakage can be inhibited, thereby inhibiting an increase in resistance. Preferably, the intermediate layer contains only the specific polyamide resin and the specific organic particles. Specifically, the total percentage content of the specific polyamide resin and the specific organic particles is preferably at least 90% by mass in the intermediate layer, more preferably at least 99% by mass, and further preferably 100% by mass.

### (Specific Polyamide Resin)

The specific polyamide resin includes a first repeating unit derived from an aliphatic dicarboxylic acid and a second repeating unit derived from a diamine compound. The total percentage content of the first repeating unit and the second repeating unit is at least 80% by mole to all repeating units included in the specific polyamide resin, preferably at least 95% by mole, and more preferably 100% by mole.

The specific polyamide resin may include one or more first repeating units and one or more second repeating units. Preferably, the specific polyamide resin includes one first repeating unit and one second repeating unit.

The aliphatic dicarboxylic acid is represented by formula “COOH—(CH2)n-COOH”, for example. The integer represented by n is preferably at least 8 and no greater than 20, and more preferably at least 8 and no greater than 12. In other words, the carbon number of the aliphatic dicarboxylic acid is preferably at least 8 and no greater than 20, and more preferably at least 8 and no greater than 12. Examples of the aliphatic dicarboxylic acid with a carbon number of at least 8 and no greater than 20 include octanedioic acid, nonanedioic acid, decanedioic acid, undecanedioic acid, dodecanedioic acid, tridecanedioic acid, tetradecanedioic acid, pentadecanedioic acid, hexadecanedioic acid, heptadecanedioic acid, octadecanedioic acid, nonadecanedioic acid, and eicosanedioic acid. Preferably, the aliphatic dicarboxylic acid is octanedioic acid, decanedioic acid, or dodecanedioic acid.

Examples of the diamine compound include aliphatic diamine compounds (e.g., aliphatic diamine compounds with a carbon number of at least 4 and no greater than 14) and diamine compounds having a cycloalkane structure. Preferably, the diamine compound is a diamine compound having a cycloalkane structure.

Examples of the cycloalkane structure of the diamine compound having a cycloalkane structure include a cyclopentane structure, a cyclohexane structure, a cycloheptane structure, a cyclooctane structure, a bicyclopentane structure, and a decalin structure. Examples of the diamine compound having a cycloalkane structure include 1,2-cyclopentanediamine, 1,3-cyclopentanediamine, 1,2-cyclohexanediamine, 1,3-cyclohexanediamine, 1,4-cyclohexanediamine, isophoronediamine, 4,4-methylenebis-2-methylcyclohexylamine, 2,5-bis(aminomethyl) bicyclo[2,2,1]heptane, and 2,6-bis(aminomethyl) bicyclo[2,2,1]heptane. The diamine compound having a cycloalkane structure s preferably isophoronediamine or 4,4-methylenebis-2-methylcyclohexylamine, and more preferably isophoronediamine.

The specific polyamide resin may include an additional repeating unit (e.g., a repeating unit derived from a lactam compound) in addition to the first repeating unit and the second repeating unit, as long as the amount thereof is small. However, it is preferable that the specific polyamide resin does not include a repeating unit derived from an aromatic dicarboxylic acid. Specifically, the repeating unit derived from an aromatic dicarboxylic acid has a percentage content of preferably no greater than 5% by mole to all repeating units included in the specific polyamide resin, more preferably no greater than 1% by mole, and further preferably 0% by mole.

Preferably, the specific polyamide resin is any of polymers of the following monomer mixtures (a1) to (a4). In the following, the polymers of the monomer mixtures (a1) to (a4) may be also referred to below as polyamide resins (a1) to (a4), respectively.
a1: mixture of dodecanedioic acid and isophoronediamine
a2: mixture of decanedioic acid and isophoronediamine
a3: mixture of octanedioic acid and isophoronediamine
a4: mixture of dodecanedioic acid and 4,4-methylenebis-2-methylcyclohexylamine

The specific polyamide resin has a percentage content of preferably at least 8% by mass and no greater than 70% by mass in the intermediate layer, and more preferably at least 12% by mass and no greater than 65% by mass. As a result of the percentage content of the specific polyamide resin being set to at least 8% by mass and no greater than 70% by mass, the specific polyamide resin can easily exhibit a function as the binder resin of the intermediate layer.

### (Specific Inorganic Particles)

The specific inorganic particles include metal oxide particles. The specific inorganic particles preferably include surface treatment layers covering at least parts of the surfaces of the respective metal oxide particles. As a result of including the surface treatment layers, the specific inorganic particles tend to be highly dispersed in the intermediate layer. The specific inorganic particles have a number average primary particle diameter of preferably at least 5 nm and no greater than 100 nm, more preferably at least 5 nm and no greater than 50 nm, and further preferably at least 5 nm and no greater than 20 nm.

The specific inorganic particles have a content of at least 50 parts by mass and no greater than 1000 parts by mass relative to 100 parts by mass of the specific polyamide resin in the intermediate layer, more preferably at least 100 parts by mass and no greater than 600 parts by mass, and further preferably at least 150 parts by mass and no greater than 500 parts by mass. As a result of the content of the specific inorganic particles being set to at least 50 parts by mass and no greater than 1000 parts by mass, the intermediate layer can further effectively play the roles of increasing adhesion between the conductive substrate and the photosensitive layer and inhibiting charge injection from the conductive substrate side to the photosensitive layer side.

### (Metal Oxide Particles)

Examples of the metal oxide particles include alumina particles, zinc oxide particles, titanium oxide particles, and particles of conductive metal oxides (e.g., phosphorous-doped tin oxide and antimony-doped tin oxide). The metal oxide particles are preferably titanium oxide particles or zinc oxide particles, and more preferably titanium oxide particles.

Note that the surface treatment layers of the specific inorganic particles are very thin. Therefore, the number average primary particle diameter of the metal oxide particles is approximately the same as the number average primary particle diameter of the specific inorganic particles.

The metal oxide particles have a percentage content of preferably at least 80% by mass and no greater than 99% by mass in the specific inorganic particles, and more preferably at least 85% by mass and no greater than 93% by mass.

### (Surface Treatment Layers)

As stated above, it is preferable that the specific inorganic particles include surface treatment layers covering at least parts of the metal oxide particles. In this case, the surface treatment layers preferably contain at least one of aluminum oxide, silica, zirconia, stearic acid, and a component derived from an organic siloxane compound. Note that aluminum oxide, silica, and the zirconia form fine particles or homogenous film on the surface treatment layers, for example. The component derived from an organic siloxane compound may be an organic siloxane compound itself or a compound generated by chemical reaction of an organic siloxane compound with the metal oxide particles, oxygen, or the like. The surface treatment layers may have a single-layer structure or a multilayer structure.

The organic siloxane compound is a compound with a siloxane bond (Si—O—Si bond) having an organic group (e.g., an alkyl group with a carbon number of at least 1 and no greater than 5 optionally substituted with a substituent, a cycloalkyl group with a carbon number of at least 4 and no greater than 8 optionally substituted with a substituent, or an aryl group with a carbon number of at least 6 and no greater than 10 optionally substituted with a substituent). Preferably, the organic group is a methyl group, an ethyl group, or a phenyl group. Note that the organic siloxane compound may be a commercially available product named “silicone oil”.

The organic siloxane compound is a polysiloxane compound substituted with an organic group, for example. Example of the polysiloxane compound substituted with an organic group include dimethylpolysiloxane, methylphenylpolysiloxane, and methylhydrogenpolysiloxane. Preferably, the organic siloxane compound is methylhydrogenpolysiloxane.

The total percentage content of any of aluminum oxide, silica, zirconia, stearic acid, and the compound derived from an organic siloxane compound is preferably at least 90% by mass in the surface treatment layers, more preferably at least 99% by mass, and further preferably 100% by mass. Preferably, the surface treatment layers contain only aluminum oxide and silica, contain only aluminum oxide, contain only aluminum oxide and zirconia, contain only silicone oil, contain only aluminum oxide, silica, and methylpolysiloxane, or contain only aluminum oxide and stearic acid.

The surface treatment layers are layers formed by surface treatment of the metal oxide particles with a surface treatment agent. Example of the surface treatment agent include organic siloxane compounds, aluminum oxide, silica, zirconia, and stearic acid. The surface treatment agent may contain a compound (e.g., aluminum hydroxide, water-containing silica hydroxide, or zirconium hydroxide) that generates aluminum oxide, silica, or zirconia by treatment such as baking. An example of the surface treatment is application of a surface treatment agent to the metal oxide particles followed by baking.

The surface treatment layers have a content of preferably at least 1 part by mass and no greater than 30 parts by mass relative to 100 parts by mass of the metal oxide particles, and more preferably at least 5 parts by mass and no greater than 20 parts by mass. As a result of the content of the surface treatment layers being set to at least 1 part by mass, dispersibility of the specific inorganic particles in the intermediate layer can be further optimized. As a result of the content of the surface treatment layers being set to no greater than 30 parts by mass, the specific inorganic particles can have optimized resistance.

The specific inorganic particles are preferably any of specific inorganic particles (t1) to (t7) that have the respective constitutions indicated in Table 1. Note that the column titled “Surface treatment layers” in Table 1 indicates the component(s) contained in the corresponding surface treatment layers. For example, “Silica+Alumina” in the column titled “Surface treatment layers” for the specific inorganic particles (t1) means that the surface treatment layers contain silica and alumina. “MHPS” refers to methylhydrogenpolysiloxane. The column titled “Number average primary particle diameter” indicates a preferable numerical range of the number average primary particle diameter of the corresponding specific inorganic particles. For example, “7-15” in the column titled “Number average primary particle diameter” for the specific inorganic particles (t1) means that the number average primary particle diameter of the specific inorganic particles (t1) is at least 7 nm and no greater than 15 nm.

TABLE 1

| | | | Number average |
|---|---|---|---|
| | | Surface treatment | primary particle |
| | Metal oxide particles | layers | diameter [nm] |
| t1 | Titanium oxide particles | Silica + Alumina | 7-15 |
| t2 | Titanium oxide particles | Alumina | 35-45 |
| t3 | Titanium oxide particles | Alumina + Zirconia | 25-35 |
| t4 | Zinc oxide particles | Silicone oil | 30-40 |
| t5 | Titanium oxide particles | Silicone oil | 75-85 |
| t6 | Titanium oxide particles | Alumina + Silica + | 30-40 |
| | | MHPS | |
| t7 | Titanium oxide particles | Alumina + Stearic acid | 10-20 |

### [Photosensitive Layer]

Preferably, the photosensitive layer contains a charge generating material, an electron transport material, a binder resin, and a hole transport material. The photosensitive layer may further contain an additive as necessary.

### (Charge Generating Material)

Examples of the charge generating material include phthalocyanine-based pigments, perylene-based pigments, bisazo pigments, tris-azo pigments, dithioketopyrrolopyrrole pigments, metal-free naphthalocyanine pigments, metal naphthalocyanine pigments, squaraine pigments, indigo pigments, azulenium pigments, cyanine pigments, powders of inorganic photoconductive materials (e.g., selenium, selenium-tellurium, selenium-arsenic, cadmium sulfide, and amorphous silicon), pyrylium pigments, anthanthrone-based pigments, triphenylmethane-based pigments, threne-based pigments, toluidine-based pigments, pyrazoline-based pigments, and quinacridone-based pigments.

The phthalocyanine-based pigments have a phthalocyanine structure. Examples of the phthalocyanine-based pigments include metal phthalocyanines and metal-free phthalocyanine. Examples of the metal phthalocyanines include titanyl phthalocyanine, hydroxygallium phthalocyanine, and chlorogallium phthalocyanine. Titanyl phthalocyanine is preferable as a metal phthalocyanine. Titanyl phthalocyanine is represented by formula (CG-1). Metal-free phthalocyanine is represented by formula (CG-2).

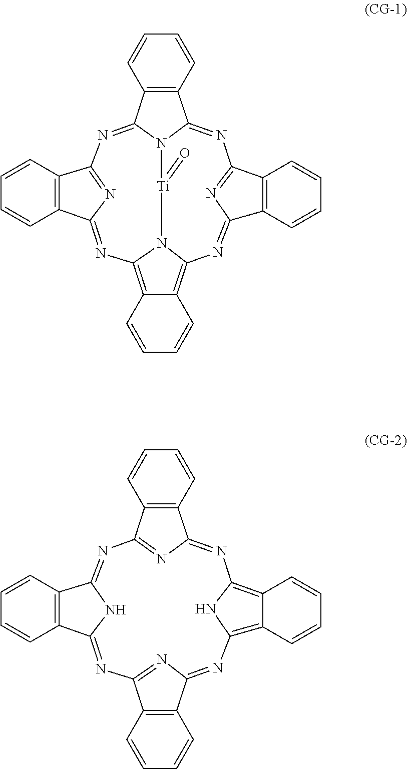

The phthalocyanine-based pigments may be crystalline or non-crystalline. An example of crystalline metal-free phthalocyanine is metal-free phthalocyanine having an X-form crystal structure (also referred to below as X-form metal-free phthalocyanine). Examples of crystalline titanyl phthalocyanine include titanyl phthalocyanine having an α-form crystal structure, titanyl phthalocyanine having a β-form crystal structure, and titanyl phthalocyanine having a Y-form crystal structure (also referred to below as α-form titanyl phthalocyanine, β-form titanyl phthalocyanine, and Y-form titanyl phthalocyanine, respectively).

For example, a photosensitive member having a sensitivity to light in a wavelength range of at least 700 nm is preferably used in digital optical image forming apparatuses (e.g., laser beam printers or facsimiles using a light source such as semiconductor laser). The charge generating material is preferably a phthalocyanine-based pigment because it exhibits a high quantum yield in a wavelength range of at least 700 nm. More preferable one is titanyl phthalocyanine or metal-free phthalocyanine, and further preferable one is Y-form titanyl phthalocyanine or X-form metal-free phthalocyanine.

Y-form titanyl phthalocyanine exhibits a main peak for example at a Bragg angle (2θ±0.2°) of 27.2° in a CuKα characteristic X-ray diffraction spectrum. The term main peak refers to a peak that is the most intense or second most intense peak within a range of Bragg angles (20+) 0.2° between 3° and 40° in a CuKα characteristic X-ray diffraction spectrum. Y-form titanyl phthalocyanine does not exhibit a peak at 26.2° in the CuKα characteristic X-ray diffraction spectrum.

The CuKα characteristic X-ray diffraction spectrum can be plotted by the following method, for example. First, a sample (titanyl phthalocyanine) is loaded into a sample holder of an X-ray diffractometer (e.g., “RINT (registered Japanese trademark) 1100”, product of Rigaku Corporation). Then, an X-ray diffraction spectrum is plotted under conditions of use of an X-ray tube made from Cu, a tube voltage of 40 kV, a tube current of 30 mA, and a wavelength of the CuKα characteristic X-ray of 1.542 Å. The measurement range (2θ) is for example from 3° to 40° (start angle: 3°, stop angle: 40°), and the scanning speed is for example 10°/min. The main peak is identified from the plotted X-ray diffraction spectrum, and the Bragg angle of the main peak is read.

The charge generating material has a content of at least 0.1 parts by mass and no greater than 10.0 parts by mass relative to 100 parts by mass of the binder resin in the photosensitive layer, and more preferably at least 1.5 parts by mass and no greater than 4.5 parts by mass.

### (Hole Transport Material)

Examples of the hole transport material include triphenylamine derivatives, diamine derivatives (e.g., an N,N,N′,N′-tetraphenylbenzidine derivative, an N,N,N′,N′-tetraphenylphenylenediamine derivative, an N,N,N′,N′-tetraphenylnaphtylenediamine derivative, an N,N,N′,N′-tetraphenylphenanthrylenediamine derivative, and an di(aminophenylethenyl)benzene derivative), oxadiazole-based compounds (e.g., 2,5-di(4-methylaminophenyl)-1,3,4-oxadiazole), styryl-based compounds (e.g., 9-(4-diethylaminostyryl) anthracene), carbazole-based compounds (e.g., polyvinyl carbazole), organic polysilane compounds, pyrazoline-based compounds (e.g., 1-phenyl-3-(p-dimethylaminophenyl) pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compound.

Examples of the hole transport material include compounds represented by formulas (10), (20), (21), (23), (24), and (25) (also referred to below as hole transport materials (10), (20), (21), (23), (24), and (25), respectively).

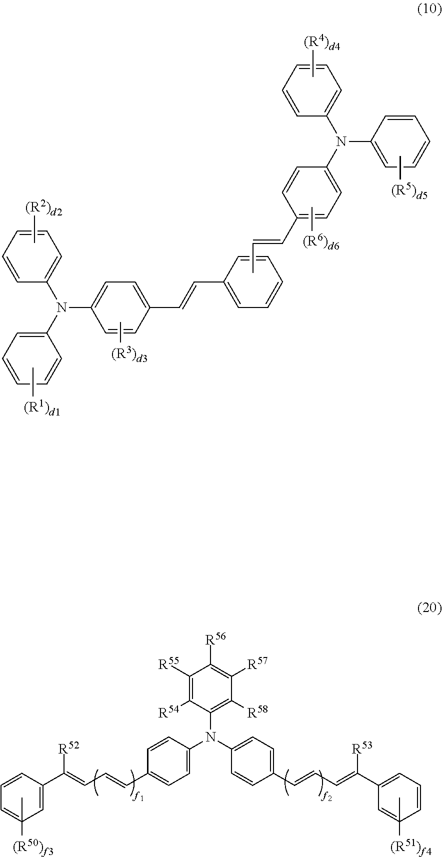

In formula (10), R¹ to R⁶ each represent, independently of one another, a phenyl group, an alkyl group with a carbon number of at least 1 and no greater than 8, or an alkoxy group with a carbon number of at least 1 and no greater than 8. d1, d2, d4, and d5 each represent, independently of one another, an integer of at least 0 and no greater than 5. d3 and d6 each represent, independently of one another, an integer of at least 0 and no greater than 4. Preferably, R¹ to R⁶ each represent, independently of one another, an alkyl group with a carbon number of at least 1 and no greater than 3. Preferably, d1, d2, d4, and d5 each represent, independently of one another, 0, 1, or 2. Preferably, d3 and d6 each represent 0.

When d1 to d6 in formula (10) each represent an integer of at least 2, the multiple chemical groups R¹ to the multiple chemical groups R⁶ may represent the same group as or different groups from each other.

In formula (20), R⁵⁰ and R⁵¹ each represent, independently of one another, a phenyl group, an alkyl group with a carbon number of at least 1 and no greater than 6, or an alkoxy group with a carbon number of at least 1 and no greater than 6. R⁵², R⁵³, R⁵⁴, R⁵⁵, R⁵⁶, R⁵⁷, and R⁵⁸ each represent, independently of one another, a hydrogen atom, an alkyl group with a carbon number of at least 1 and no greater than 6, an alkoxy group with a carbon number of at least 1 and no greater than 6, or a phenyl group optionally substituted with an alkyl group with a carbon number of at least 1 and no greater than 6. f₁ and f₂ each represent, independently of one another, an integer of at least 0 and no greater than 2. f³ and f⁴ each represent, independently of one another, an integer of at least 0 and no greater than 5.

In formula (20), when f³ represents an integer of at least 2 and no greater than 5, the multiple chemical groups R⁵⁰ may represent the same group as or different groups from each other. When f⁴ represents an integer of at least 2 and no greater than 5, the multiple chemical groups R⁵¹ may represent the same group as or different groups from each other.

In formula (20), preferably, R⁵⁰ and R⁵¹ each represent, independently of one another, an alkyl group with a carbon number of at least 1 and no greater than 3. Preferably, R⁵² and R⁵³ each represent a hydrogen atom or a phenyl group optionally substituted with a methyl group. Preferably, R⁵⁴ to R⁵⁸ each represent, independently of one another, a hydrogen atom, an alkyl group with a carbon number of at least 1 and no greater than 4, or an alkoxy group with a carbon number of at least 1 and no greater than 3. Preferably, f₁ and f₂ each represent 0 or each represent 1. Preferably, f³ and f⁴ each represent, independently of one another, 0 or 1.

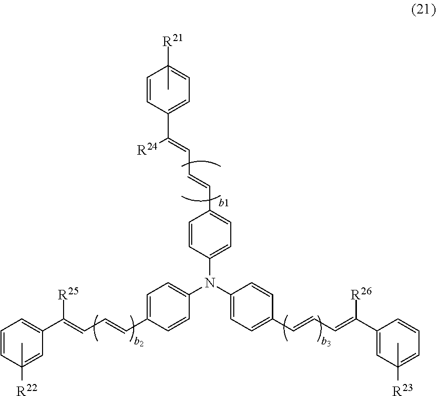

In formula (21), R²¹, R²², and R²³ each represent, independently of one another, an alkyl group with a carbon number of at least 1 and no greater than 6. R²⁴, R²⁵, and R²⁶ each represent, independently of one another, a hydrogen atom or an alkyl group with a carbon number of at least 1 and no greater than 6. b₁, b₂, and b₃ each represent, independently of one another, 0 or 1.

In formula (21), preferably, R²¹, R²², and R²³ each represent, independently of one another, an alkyl group with a carbon number of at least 1 and no greater than 3, and more preferably represent a methyl group. R²¹, R²², and R²³ are preferably bonded to a phenyl group at the meta-position thereof relative to an ethenyl or a butadienyl group. Preferably, R²⁴, R²⁵, and R²⁶ each represent a hydrogen atom. Preferably, b₁, b₂, and b₃ each represent 0 or each represent 1.

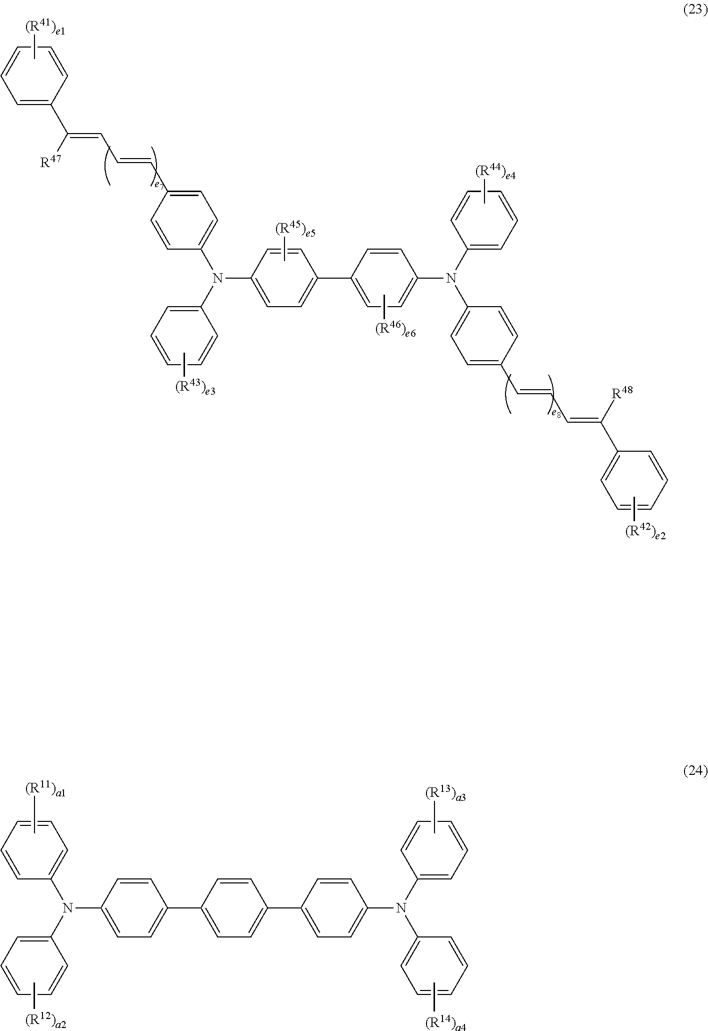

In formula (23), R⁴¹, R⁴², R⁴³, R⁴⁴, R⁴⁵, and R⁴⁶ each represent, independently of one another, a phenyl group or an alkyl group with a carbon number of at least 1 and no greater than 6. R⁴⁷ and R⁴⁸ each represent, independently of one another, a hydrogen atom, a phenyl group, or an alkyl group with a carbon number of at least 1 and no greater than 6. e₁, e₂, e₃, and e₄ each represent, independently of one another, an integer of at least 0 and no greater than 5. e₅ and e₆ each represent, independently of one another, an integer of at least 0 and no greater than 4. e₇ and e₈ each represent, independently of one another, 0 or 1.

In formula (23), when e₁ to e₆ each represent an integer of at least 2 and no greater than 4, the multiple chemical groups R⁴¹ to the multiple chemical groups R⁴⁶ may represent the same group as or different groups from each other.

In formula (23), preferably, R⁴¹ to R⁴⁶ each represent, independently of one another, an alkyl group with a carbon number of at least 1 and no greater than 3. Preferably, R⁴⁷ and R⁴⁸ each represent a hydrogen atom. Preferably, e₁, e₂, e₅, and e₆ each represent 0. Preferably, e₃ and e₄ each represent 2. Preferably, e₇ and e₈ each represent 0 or each represent 1.

In formula (24), R¹¹, R¹², R¹³, and R¹⁴ each represent, independently of one another, an alkyl group with a carbon number of at least 1 and no greater than 6 or an alkoxy group with a carbon number of at least 1 and no greater than 6. a1, a2, a3, and a4 each represent, independently of one another, an integer of at least 0 and no greater than 5.

In formula (24), when a1 to a4 each represent an integer of at least 2 and no greater than 5, the multiple chemical groups R¹¹ to the multiple chemical groups R¹⁴ may represent the same group as or different groups from each other.

In formula (24), preferably, R¹¹, R¹², R¹³, and R¹⁴ each represent, independently of one another, an alkyl group with a carbon number of at least 1 and no greater than 3. Preferably, a1, a2, a3, and a4 each represent, independently of one another, 0 or 1.

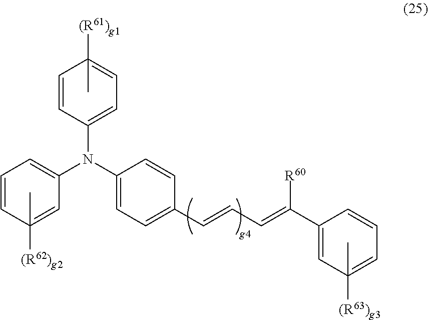

In formula (25), R⁶⁰ represents a hydrogen atom, an alkyl group with a carbon number of at least 1 and no greater than 8, an alkoxy group with a carbon number of at least 1 and no greater than 8, or a phenyl group optionally substituted with an alkyl group with a carbon number of at least 1 and no greater than 8. R⁶¹, R⁶², and R⁶³ each represent, independently of one another, an alkyl group with a carbon number of at least 1 and no greater than 8 or an alkoxy group with a carbon number of at least 1 and no greater than 8. g1, g2, and g3 each represent, independently of one another, an integer of at least 0 and no greater than 5. g4 represents 0 or 1. Preferably, R⁶⁰ represents a phenyl group. Preferably, R⁶¹, R⁶², and R⁶³ each represent, independently of one another, an alkyl group with a carbon number of at least 1 and no greater than 3. Preferably, g1 and g2 each represent 1. Preferably, g3 represents 0.

In formula (25), when g1 to g3 each represent an integer of at least 2 and no greater than 5, the multiple chemical groups R⁶¹ to the multiple chemical groups R⁶³ may represent the same group as or different groups from each other.

The hole transport material preferably includes at least one of compounds represented by formulas (HTM-1) to (HTM-12) (also referred to below as hole transport materials (HTM-1) to (HTM-12), respectively).

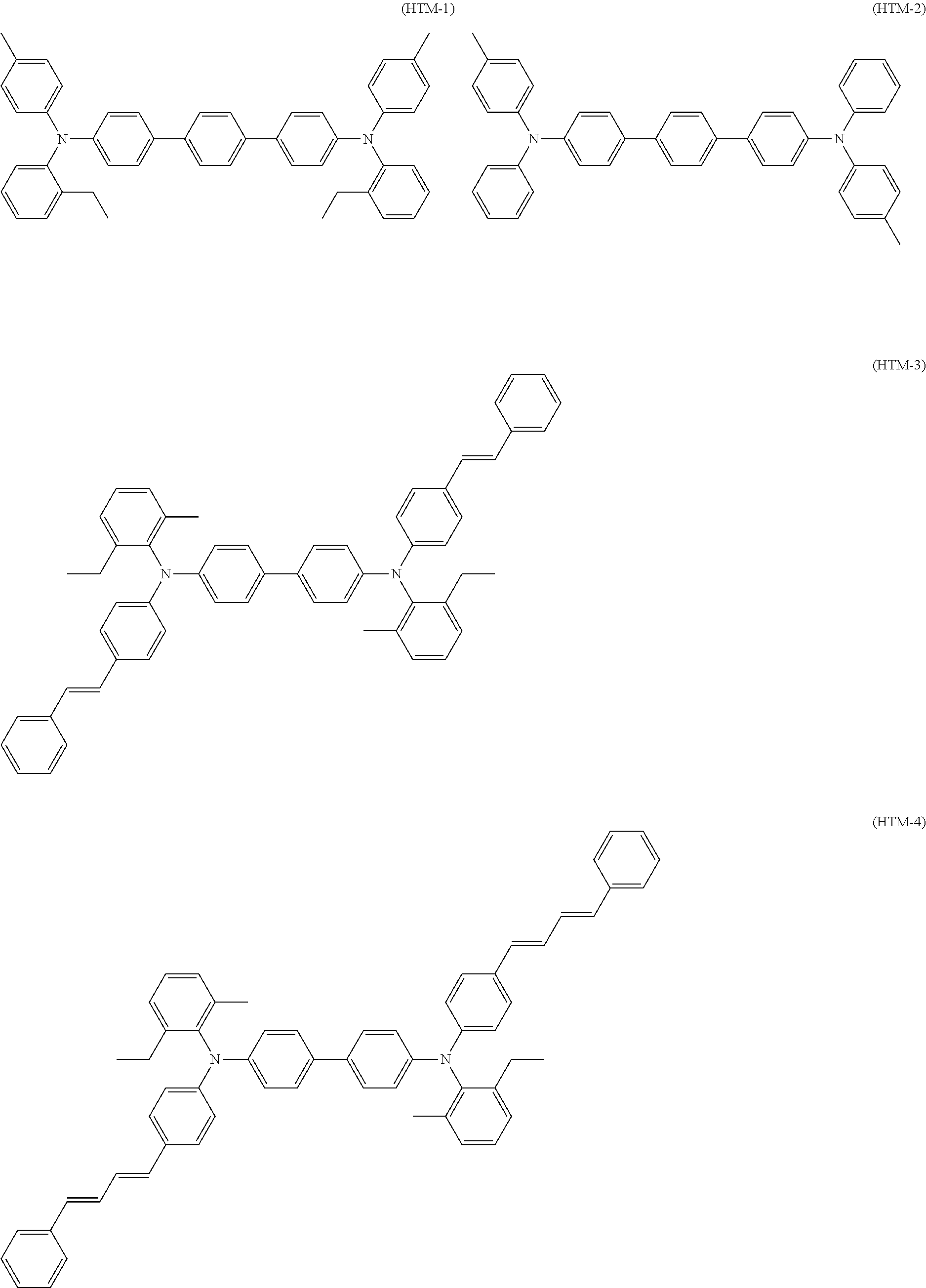

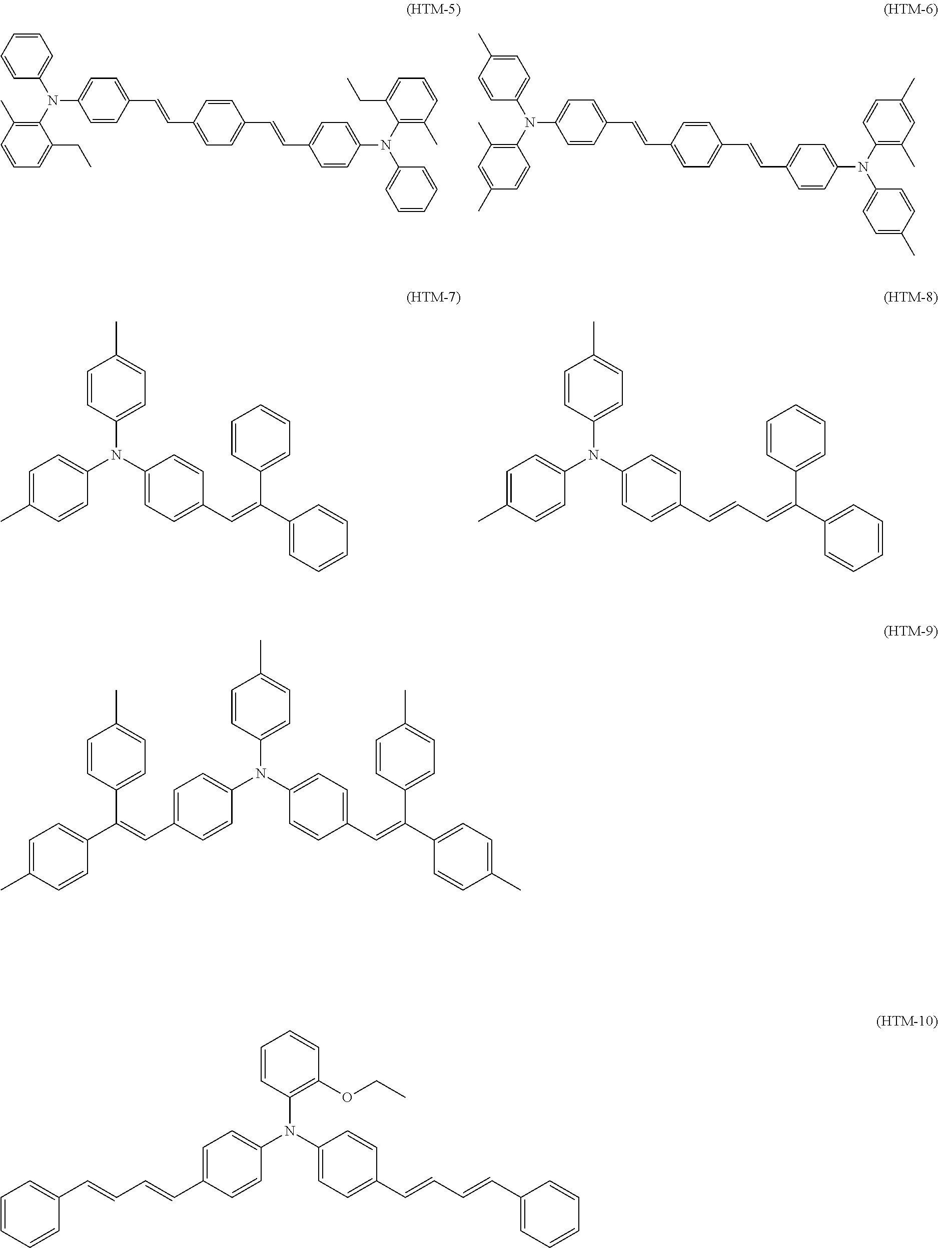

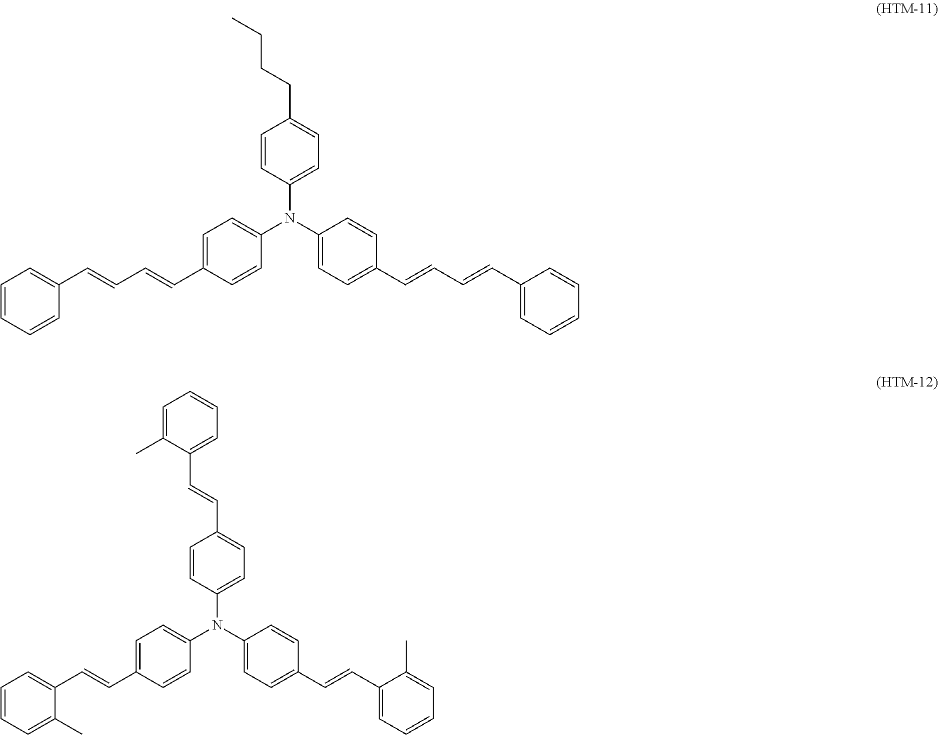 [SMILES: CCCCc1ccc(N(c2ccc(/C=C/C=C/c3ccccc3)cc2)c2ccc(/C=C/C=C/c3ccccc3)cc2)cc1 ; Cc1ccccc1/C=C/c1ccc(N(c2ccc(/C=C/c3ccccc3C)cc2)c2ccc(/C=C/c3ccccc3C)cc2)cc1]

The total percentage content of any of the hole transport materials (10), (20), (21), (23), (24), and (25) is preferably at least 80% by mass to the total hole transport material amount, more preferably at least 90% by mass, and further preferably 100% by 5 mass.

The hole transport material has a content of preferably at least 10 parts by mass and no greater than 200 parts by mass relative to 100 parts by mass of the binder resin in the photosensitive layer, and more preferably at least 50 parts by mass and no greater than 100 parts by mass. As a result of the content of the hole transport material being set to at least 10 parts by mass and no greater than 200 parts by mass, the photosensitive member can have further effectively reduced environmental dependence of sensitivity and can further effectively inhibit occurrence of fogging in high-temperature and high-humidity environments.

### (Electron Transport Material)

Examples of the electron transport material include quinone-based compounds, diimide-based compounds, hydrazone-based compounds, malononitrile-based compounds, thiopyran-based compounds, trinitrothioxanthone-based compounds, 3,4,5,7-tetranitro-9-fluorenone-based compounds, dinitroanthracene-based compounds, dinitroacridine-based compounds, tetracyanoethylene, 2,4,8-trinitrothioxanthone, dinitrobenzene, dinitroacridine, succinic anhydride, maleic anhydride, and dibromomaleic anhydride. Examples of the quinone-based compounds include diphenoquinone-based compounds, azoquinone-based compounds, anthraquinone-based compounds, naphthoquinone-based compounds, nitroanthraquinone-based compounds, and dinitroanthraquinone-based compounds.

The electron transport material includes at least one of compounds represented by formulas (11) to (17). In the following, the compounds represented by formulas (11) to (17) may be also referred to below as electron transport materials (11) to (17), respectively.

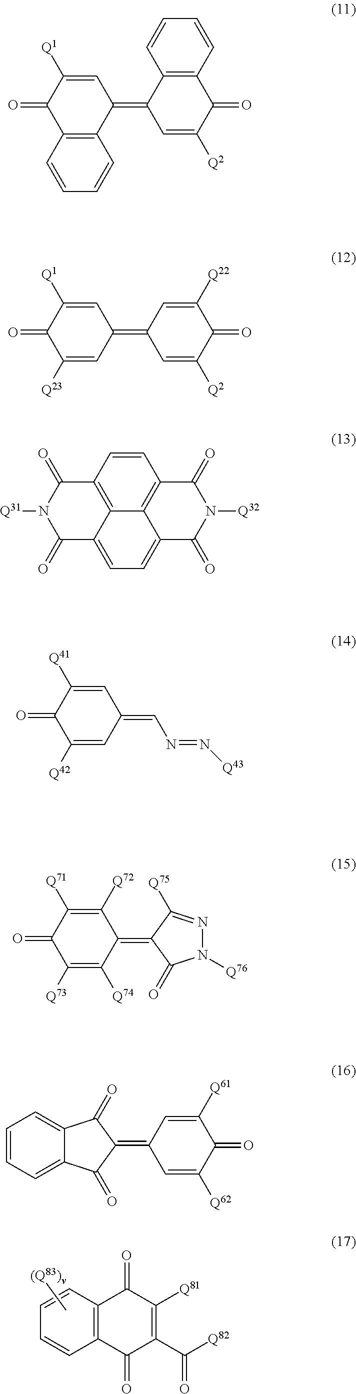

Q¹ and Q² in formula (11), Q²¹, Q²², Q²³, and Q²⁴ in formula (12), Q³¹ and Q³² in formula (13), Q⁴¹, Q⁴², and Q⁴³ in formula (14), Q⁷¹, Q⁷², Q⁷³, Q⁷⁴, Q⁷⁵, and Q⁷⁶ in formula (15), and Q⁶¹ and Q⁶² in formula (16) each represent, independently of one another, a hydrogen atom, a halogen atom, a cyano group, an alkyl group with a carbon number of at least 1 and no greater than 6, an alkenyl group with a carbon number of at least 2 and no greater than 6, an alkoxy group with a carbon number of at least 1 and no greater than 6, or an aryl group with a carbon number of at least 6 and no greater than 14 optionally substituted with at least one specific substituent. The specific substituent is at least one substituent selected from the group consisting of a halogen atom and an alkyl group with a carbon number of at least 1 and no greater than 6.

Preferably, Q¹ and Q² in formula (11) each represent, independently of one another, an alkyl group with a carbon number of at least 4 and no greater than 6. Preferably, Q²¹, Q²², Q²³, and Q²⁴ in formula (12) each represent, independently of one another, an alkyl group with a carbon number of at least 1 and no greater than 5. Preferably, Q³¹ and Q³² in formula (13) each represent, independently of one another, a phenyl group optionally substituted with an alkyl group with a carbon number of at least 1 and no greater than 3. Preferably, Q⁴¹ and Q⁴² in formula (14) each represent, independently of one another, an alkyl group with a carbon number of at least 3 and no greater than 5. Preferably, Q⁴³ in formula (14) represents a phenyl group optionally substituted with a halogen atom. Preferably, Q⁷¹ and Q⁷³ in formula (15) each represent, independently of one another, an alkyl group with a carbon number of at least 3 and no greater than 5. Preferably, Q⁷² and Q⁷⁴ in formula (15) each represent a hydrogen atom. Preferably, Q⁷⁵ in formula (15) represents a phenyl group or an alkyl group with a carbon number of at least 2 and no greater than 4. Preferably, Q⁷⁶ in formula (15) represents a phenyl group optionally substituted with a halogen atom or an alkyl group with a carbon number of at least 3 and no greater than 5. Preferably, Q⁶¹ and Q⁶² in formula (16) each represent, independently of one another, an alkyl group with a carbon number of at least 3 and no greater than 5.

In formula (17), Q⁸¹ represents an alkyl group with a carbon number of at least 1 and no greater than 6 or an aryl group with a carbon number of at least 6 and no greater than 14. Q⁸² represents an alkyl group with a carbon number of at least 1 and no greater than 6, an aryl group with a carbon number of at least 6 and no greater than 14, an alkoxy group with a carbon number of at least 1 and no greater than 6, an aralkyl group with a carbon number of at least 7 and no greater than 20, an aryloxy group with a carbon number of at least 6 and no greater than 14, or an aralkyloxy group with a carbon number of at least 7 and no greater than 20. Q⁸³ represents an alkyl group with a carbon number of at least 1 and no greater than 6. v represents an integer of at least 0 and on greater than 4. Preferably, Q⁸¹ represents a phenyl group. Preferably, Q⁸² represents an aralkyloxy group with a carbon number of at least 7 and no greater than 8. Preferably, Q⁸³ represents an alkyl group with a carbon number of at least 1 and no greater than 3. Preferably, v represents 0.

Preferably, the electron transport material includes at least one of compounds represented by formulas (ETM-1) to (ETM-8) (also referred to below as electron transport materials (ETM-1) to (ETM-8), respectively).

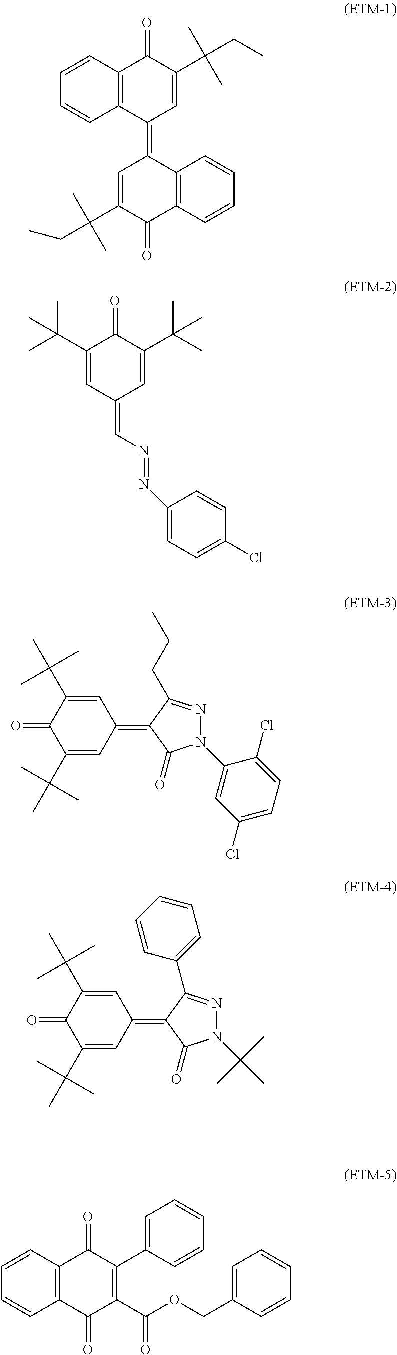

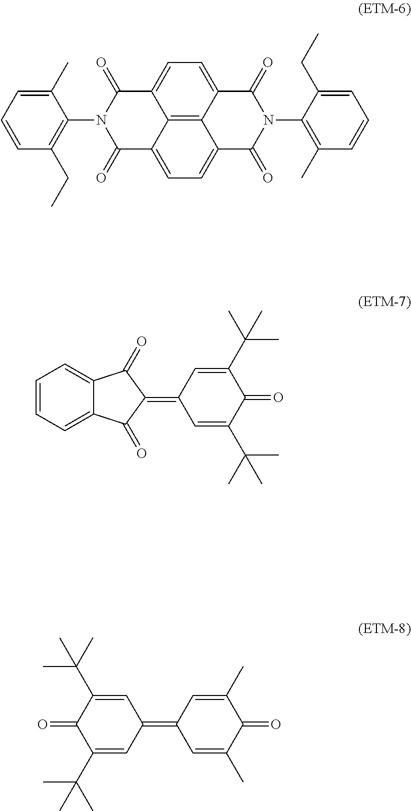 [SMILES: CCc1cccc(C)c1N1C(=O)c2ccc3c4c(ccc(c24)C1=O)C(=O)N(c1c(C)cccc1CC)C3=O ; CC(C)(C)C1=CC(=C2C(=O)c3ccccc3C2=O)C=C(C(C)(C)C)C1=O ; CC1=CC(=C2C=C(C(C)(C)C)C(=O)C(C(C)(C)C)=C2)C=C(C)C1=O]

The total percentage content of any of the electron transport materials (11) to (17) is preferably at least 80% by mass to the total electron transport material amount. more preferably at least 90% by mass, and further preferably 100% by mass.

The electron transport material has a content of preferably at least 5 parts by mass and no greater than 150 parts by mass relative to 100 parts by mass of the binder resin in the photosensitive layer, and more preferably at least 30 parts by mass and no greater than 60 parts by mass. As a result of the content of the electron transport material being set to at least 5 parts by mass and no greater than 150 parts by mass, the photosensitive member can have further effectively reduced environmental dependence of sensitivity and can further effectively inhibit occurrence of fogging in high-temperature and high-humidity environments.

### (Binder Resin)

Examples of the binder resin include thermoplastic resins (specific examples include polyarylate resin, polycarbonate resin, styrene-based resin, styrene-butadiene copolymers, styrene-acrylonitrile copolymers, styrene-maleic acid copolymers, styrene-acrylic acid copolymers, acrylic copolymers, polyethylene resins, ethylene-vinyl acetate copolymers, chlorinated polyethylene resins, polyvinyl chloride resins, polypropylene resins, ionomers, vinyl chloride-vinyl acetate copolymers, polyester resins, alkyd resins, polyamide resins, polyurethane resins, polysulfone resins, diallyl phthalate resins, ketone resins, polyvinyl butyral resins, polyvinyl acetal resins, and polyether resin), thermosetting resins (specific examples include silicone resins, epoxy resins, phenolic resins, urea resins, melamine resins, and crosslinkable thermosetting resins other than these), and photocurable resins (specific examples include epoxy-acrylic acid-based resins and urethane-acrylic acid-based copolymers).

Among these resins, a polycarbonate resin is preferable because single-layer photosensitive layers and charge transport layers can be obtained that have an excellent balance of workability, mechanical strength, optical properties, and abrasion resistance. Examples of the polycarbonate resin include bisphenol Z polycarbonate resin, bisphenol B polycarbonate resin, bisphenol ZC polycarbonate resin, bisphenol C polycarbonate resin, and bisphenol A polycarbonate resin. The binder resin is preferably, but not particularly limited to, bisphenol Z polycarbonate resin. Bisphenol Z polycarbonate resin is a resin including a repeating unit represented by formula (BisZ).

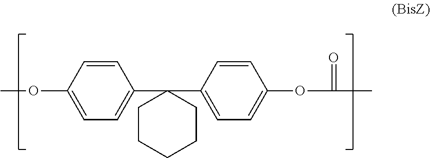

The binder resin has a percentage content of preferably at least 20% by mass and no greater than 60% by mass in the photosensitive layer, and more preferably at least 40% by mass and no greater than 50% by mass.

### (Additive)

Examples of the additive contained in the photosensitive layer include an ultraviolet absorbing agent, an antioxidant, a radical scavenger, a singlet quencher, a softener, a surface modifier, an extender, a thickener, a dispersion stabilizer, a wax, a donor, a surfactant, a plasticizer, a sensitizer, an electron acceptor compound, and a leveling agent. Example of the leveling agent include silicone oils, and a specific example thereof is dimethyl silicone oil.

The photosensitive layer preferably contains a silicone oil. In this case, the content of the silicone oil is preferably at least 0.01 parts by mass and no greater than 0.5 parts by mass relative to 100 parts by mass of the binder resin in the photosensitive layer.

### [Conductive Substrate]

The conductive substrate is not particularly limited so long as at least a surface portion thereof is constituted by a conductive material. An example of the conductive substrate is a conductive substrate constituted by a conductive material. Another example of the conductive substrate is a conductive substrate covered with a conductive material. Examples of the conductive material include aluminum, iron, copper, tin, platinum, silver, vanadium, molybdenum, chromium, cadmium, titanium, nickel, palladium, and indium. An alloy (specific examples include aluminum alloys, stainless steel, and brass) may be used by combining two or more conductive materials. In terms of achieving favorable charge mobility from the photosensitive layer to the conductive substrate, the conductive material is preferably aluminum or an aluminum alloy. The shape of the conductive substrate is appropriately selected according to the configuration of an image forming apparatus that includes the conductive substrate. The conductive substrate can be in the shape of a sheet or a drum, for example. The thickness of the conductive substrate is appropriately selected according to the shape of the conductive substrate.

### [Photosensitive Member Production Method]

An example of a photosensitive member production method is described next. The photosensitive member production method includes an intermediate layer formation process and a photosensitive layer formation process, for example.

### (Intermediate Layer Formation Process)

In the intermediate layer formation process, an application liquid (also referred to below as an application liquid for intermediate layer formation) for forming an intermediate layer is prepared. The application liquid for intermediate layer formation contains specific inorganic particles, a specific polyamide resin, and a solvent. Next, the application liquid for intermediate layer formation is applied onto a conductive substrate. Next, at least a portion of the solvent contained in the application liquid for intermediate layer formation is removed to form an intermediate layer.

### (Photosensitive Layer Formation Process)

In the photosensitive layer formation process, an application liquid (also referred to below as an application liquid for photosensitive layer formation) for forming a photosensitive layer is prepared. The application liquid for photosensitive layer formation contains a charge generating material, an electron transport material, a binder resin, a hole transport material, a solvent, and an optional component (e.g., an additive), for example. The application liquid for photosensitive layer formation is prepared by mixing the above components. Next, the application liquid for photosensitive layer formation is applied onto the intermediate layer. Next, at least a portion of the solvent contained in the application liquid for photosensitive layer formation is removed to form a photosensitive layer.

The solvents contained in the application liquid for intermediate layer formation and the application liquid for photosensitive layer formation (also referred to below collectively as application liquids) are not limited particularly so long as they can dissolve or disperse each component contained in the respective application liquids. Examples of the solvents include alcohols (specific examples include methanol, ethanol, isopropanol, and butanol), aliphatic hydrocarbons (specific examples include n-hexane, octane, and cyclohexane), aromatic hydrocarbons (specific examples include benzene, toluene, and xylene), halogenated hydrocarbons (specific examples include methylene chloride, chloroform, ethylene chloride, dichloromethane, dichloroethane, carbon tetrachloride, and chlorobenzene), ethers (specific examples include dioxane, dimethyl ether, diethyl ether, tetrahydrofuran, ethylene glycol dimethyl ether, propylene glycol monomethyl ether, and diethylene glycol dimethyl ether), ketones (specific examples include acetone, methyl ethyl ketone, 2-butanone, and cyclohexanone), esters (specific examples include ethyl acetate and methyl acetate), dimethyl formaldehyde, dimethyl formamide, and dimethyl sulfoxide.

The application liquids are prepared by mixing the corresponding components to dissolve or disperse the components in the respective solvents. Mixing can be performed using for example a bead mill, a ball mill, a roll mill, a paint shaker, or an ultrasonic disperser.

A method for applying the application liquids is not limited particularly as long as it can achieve uniform application of the application liquids. Examples of the application method include dip coating, spray coating, bead coating, blade coating, and roller coating.

The method for removing at least a portion of the solvent contained in the application liquid for intermediate layer formation or the application liquid for photosensitive layer formation may be heating, pressure reduction, or a combination of heating and pressure reduction, for example. A specific example is thermal treatment (hot air drying) using a high-temperature dryer or a vacuum dryer. The temperature of the thermal treatment is at least 40° C. and no greater than 150° C., for example. The time for the thermal treatment is at least 3 minutes and no greater than 150 minutes, for example.

### [Preferable Constitution of Photosensitive Member]

The photosensitive member preferably has any of constitutions (1) to (28) shown in Table 2. Note that the terms in Table 2 are as follows.

CGM: charge generating material

CGM-1: Y-form titanyl phthalocyanine

HTM: hole transport material

ETM: electron transport material

BisZ: bisphenol Z polycarbonate resin

In Table 2, the constitution (1), for example, means a photosensitive member in which: the intermediate layer contains the specific inorganic particles (t1) and the polyamide resin (a1); and the photosensitive layer contains Y-form titanyl phthalocyanine, the hole transport material (HTM-1), the electron transport material (ETM-1), and bisphenol Z polycarbonate resin.

TABLE 2

| | Intermediate layer | | Photosensitive layer | | | |
|---|---|---|---|---|---|---|
| | Specific inorganic | Polyamide | | | | Binder |
| Constitution | particles | resin | CGM | HTM | ETM | resin |
| 1 | t1 | a1 | CGM-1 | HTM-1 | ETM-1 | BisZ |
| 2 | t1 | a2 | CGM-1 | HTM-1 | ETM-1 | BisZ |
| 3 | t1 | a3 | CGM-1 | HTM-1 | ETM-1 | BisZ |
| 4 | t1 | a4 | CGM-1 | HTM-1 | ETM-1 | BisZ |
| 5 | t2 | a1 | CGM-1 | HTM-1 | ETM-1 | BisZ |
| 6 | t3 | a1 | CGM-1 | HTM-1 | ETM-1 | BisZ |
| 7 | t4 | a1 | CGM-1 | HTM-1 | ETM-1 | BisZ |
| 8 | t5 | a1 | CGM-1 | HTM-1 | ETM-1 | BisZ |
| 9 | t6 | a1 | CGM-1 | HTM-1 | ETM-1 | BisZ |
| 10 | t7 | a1 | CGM-1 | HTM-1 | ETM-1 | BisZ |
| 11 | t1 | a1 | CGM-1 | HTM-2 | ETM-1 | BisZ |
| 12 | t1 | a1 | CGM-1 | HTM-3 | ETM-1 | BisZ |
| 13 | t1 | a1 | CGM-1 | HTM-4 | ETM-1 | BisZ |
| 14 | t1 | a1 | CGM-1 | HTM-5 | ETM-1 | BisZ |
| 15 | t1 | a1 | CGM-1 | HTM-6 | ETM-1 | BisZ |
| 16 | t1 | a1 | CGM-1 | HTM-7 | ETM-1 | BisZ |
| 17 | t1 | a1 | CGM-1 | HTM-8 | ETM-1 | BisZ |
| 18 | t1 | a1 | CGM-1 | HTM-9 | ETM-1 | BisZ |
| 19 | t1 | a1 | CGM-1 | HTM-10 | ETM-1 | BisZ |
| 20 | t1 | a1 | CGM-1 | HTM-11 | ETM-1 | BisZ |
| 21 | t1 | a1 | CGM-1 | HTM-12 | ETM-1 | BisZ |
| 22 | t1 | a1 | CGM-1 | HTM-1 | ETM-2 | BisZ |
| 23 | t1 | a1 | CGM-1 | HTM-1 | ETM-3 | BisZ |
| 24 | t1 | a1 | CGM-1 | HTM-1 | ETM-4 | BisZ |
| 25 | t1 | a1 | CGM-1 | HTM-1 | ETM-5 | BisZ |
| 26 | t1 | a1 | CGM-1 | HTM-1 | ETM-6 | BisZ |
| 27 | t1 | a1 | CGM-1 | HTM-1 | ETM-7 | BisZ |
| 28 | t1 | a1 | CGM-1 | HTM-1 | ETM-8 | BisZ |

### [Details of Image Forming Apparatus]

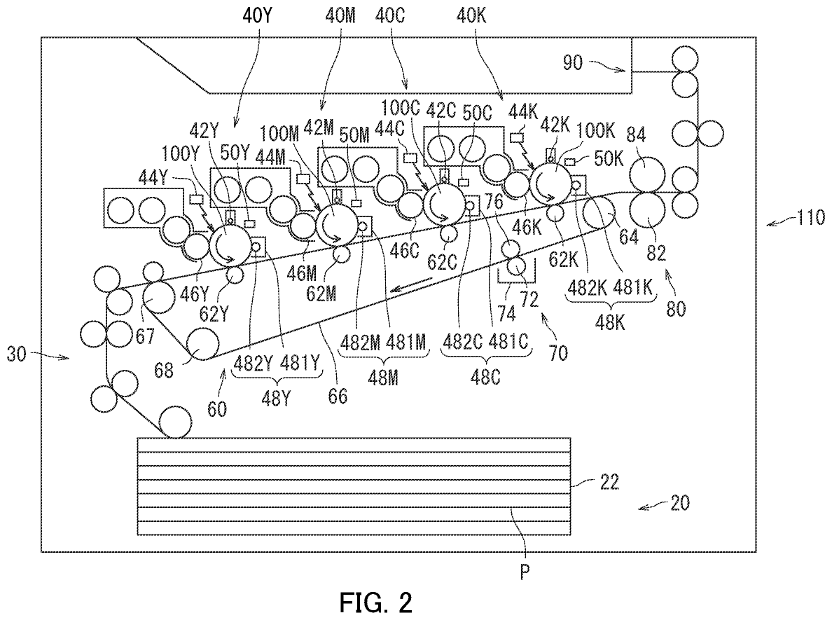

The configurations of elements in the image forming apparatus of the present embodiment other than the photosensitive member are described next in detail. FIG. 2 is a cross-sectional view of an image forming apparatus 110, which is an example of the image forming apparatus of the present embodiment.

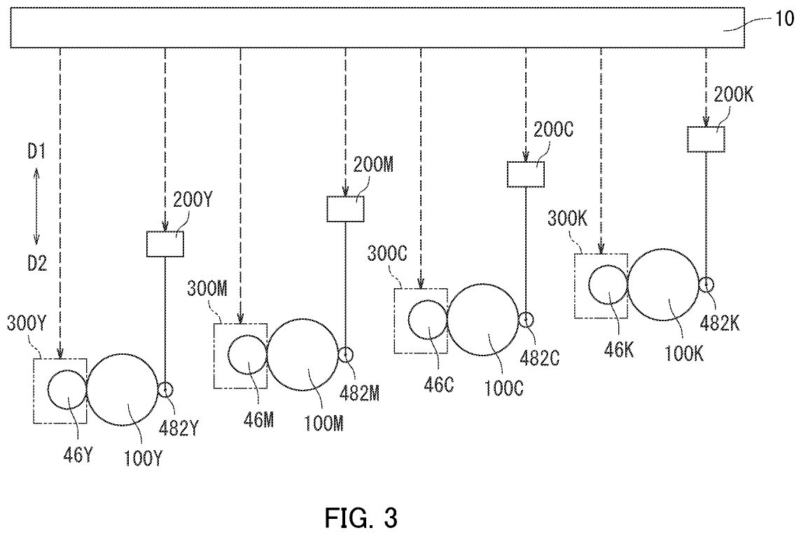

The image forming apparatus 110 illustrated in FIG. 2 includes a controller 10 (see FIG. 3), a feeding section 20, a conveyance section 30, image forming units 40Y, 40M, 40C, and 40K, a transfer section 60, a belt cleaning section 70, a fixing section 80, and a sheet ejection section 90. Note that the belt cleaning section 70 is described in detail in the following description in <Printing Mode and Cleaning Mode>.

The controller 10 controls operation of each element (specific examples include the feeding section 20, the conveyance section 30, the image forming units 40Y, 40M, 40C, and 40K, the transfer section 60, the belt cleaning section 70, the fixing section 80, and the sheet ejection section 90) of the image forming apparatus 110. The controller 10 is placed at an appropriate location within the main body casing of the image forming apparatus 110. The controller 10 includes a central processing unit (CPU), random access memory (RAM), read only memory (ROM), and an input and output interface, which are not illustrated, for example. The controller 10 performs control by executing various arithmetic processing based on preset programs and results of detection by various sensors.

The feeding section 20 includes a cassette 22. The cassette 22 accommodates multiple sheets P of a recording medium. The feeding section 20 feeds the sheets P of the recording medium from the cassette 22 to the conveyance section 30 one at a time. The sheets P of the recording medium are sheets of paper or cloth or synthetic resin sheets.

The conveyance section 30 conveys the sheet P to the image forming units 40Y, 40M, 40C, and 40K.

The image forming units 40Y, 40M, 40C, and 40K respectively include: image bearing members 100Y, 100M, 100C, and 100K; chargers 42Y, 42M, 42C, and 42K; light exposure devices 44Y, 44M, 44C, and 44K; development devices 46Y, 46M, 46C, and 46K; cleaners 48Y, 48M, 48C, and 48K; and static eliminators 50Y, 50M, 50C, and 50K. In the following description, where there is no need to distinguish, the subscripts “Y”, “M”, “C”, and “K” are omitted for each member of the image forming apparatus 110. For example, where there is no need to distinguish, each of the image forming units 40Y, 40M, 40C, and 40K is referred to as an image forming unit 40.

The transfer section 60 include four transfer devices 62Y, 62M, 62C, and 62K, a drive roller 64, an endless transfer belt 66, a driven roller 67, and a tension roller 68. The transfer devices 62Y, 62M, 62C, and 62K are each placed on the inner side of the transfer belt 66 to be opposite to the image bearing members 100Y, 100M, 100C, and 100K, respectively, with the transfer belt 66 therebetween. The transfer belt 66 is wound around the drive roller 64, the driven roller 67, and the tension roller 68. Rotation of the drive roller 64 circulates the transfer belt 66 in an arrow direction (clockwise direction) in FIG. 2.

The image bearing members 100 are each provided at the central part of a corresponding one of the image forming units 40. The image bearing member 100 is provided in a rotatable manner in an arrow direction (anticlockwise direction) in FIG. 2. A charger 42, a light exposure device 44, a development device 46, a transfer device 62, a cleaner 48, and a static eliminator 50 are arranged around the image bearing member 100 in the stated order from upstream in the rotation direction of the image bearing member 100.

The image bearing member 100 is the aforementioned photosensitive member (e.g., the photosensitive member 1 in FIG. 1).

The charger 42 charges the surface (e.g., the circumferential surface) of the image bearing member 100 to positive polarity. The charger 42 is a scorotron charger, for example.

The light exposure device 44 exposes the charged surface of the image bearing member 100 to light. Thus, an electrostatic latent image is formed on the surface of the image bearing member 100. The electrostatic latent image is formed based on image data input to the image forming apparatus 110.

The development device 46 develops the electrostatic latent image into a toner image by supplying toner to the surface of the image bearing member 100. The toner is a positively chargeable toner. The development device 46 is in contact with the image bearing member 100. That is, the image forming apparatus 110 adopts the contact development scheme. The development device 46 is a development roller, for example.

In a case in which the developer is a one-component developer, the development device 46 supplies a toner being the one-component developer to the electrostatic latent image formed on the image bearing member 100. In a case in which the developer is a two-component developer, the development device 46 supplies a toner of the two-component developer containing the toner and a carrier to the electrostatic latent image formed on the image bearing member 100. The image bearing member 100 carries the toner image formed with the supplied toner.

The transfer belt 66 conveys the sheet P between the image bearing member 100 and the transfer device 62. The transfer device 62 transfers the toner image developed by the development device 46 from the surface of the image bearing member 100 to the sheet P being a transfer target. During transfer, the surface of the image bearing member 100 is in contact with the sheet P. That is, the image forming apparatus 110 adopts the direct transfer process. The transfer device 62 is a transfer roller, for example.

Toner images in respective multiple colors (e.g., 4 colors of yellow, magenta, cyan, and black) are superimposed on the sheet P placed on the transfer belt 66 to form an unfixed toner image by a combination of the image forming unit 40Y and the transfer device 62Y, a combination of the image forming unit 40M and the transfer device 62M, a combination of the image forming unit 40C and the transfer device 62C, and a combination of the image forming unit 40K and the transfer device 62K.

The cleaners 48Y, 48M, 48C, and 48K respectively includes housings 481Y, 481M, 481C, and 481K and cleaning members 482Y, 482M, 482C, and 482K. The cleaning members 482 each are placed in a corresponding one of the housings 481. The cleaning member 482 is in contact with the surface of the corresponding image bearing member 100. The cleaning member 482 polishes the surface of the image bearing member 100 to collect toner attached to the surface of the image bearing member 100 into the housing 481. In the manner described above, the cleaner 48 collects toner attached to the surface of the image bearing member 100. The cleaning member 482 is a cleaning roller or a cleaning brush, for example.

The static eliminator 50 eliminates static on the surface of the image bearing member 100.

The sheet P with the unfixed toner image formed thereon is conveyed to the fixing section 80. The fixing section 80 includes a pressure member 82 and a heating member 84. The pressure member 82 and the heating member 84 apply heat and pressure, respectively, to the sheet P to fix the unfixed toner image to the sheet P.

The sheet P with the toner image fixed thereto is ejected out of the sheet ejection section 90.

### <Printing Mode and Cleaning Mode.

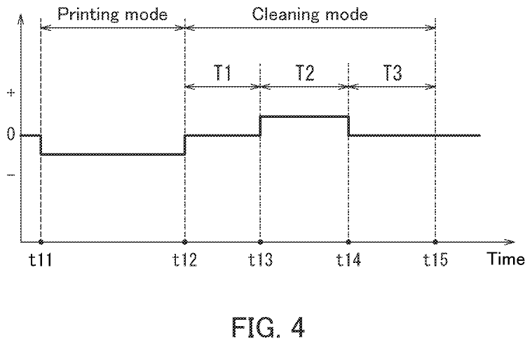

With reference to FIGS. 3 and 4 in addition to FIG. 2, operation of the image forming apparatus 110 in a printing mode and a cleaning mode is described next. FIG. 3 is a diagram illustrating the image bearing member 100 and the cleaning member 482 illustrated in FIG. 2 and the controller 10. FIG. 4 is a time chart depicting control of the cleaning member 482 in the printing mode and the cleaning mode. In FIG. 4, the horizontal axis indicates time while the vertical axis indicates voltage applied to the cleaning member 482. On the vertical axis in FIG. 4, the sign “+” indicates application of voltage with positive polarity, “0” indicates application of no voltage, and the sign “−” indicates application of voltage with negative polarity.

As previously described with reference to FIG. 2, the image forming apparatus 110 includes a controller 10 and a belt cleaning section 70. As illustrated in FIG. 3, the image forming apparatus 110 further includes voltage applicators 200Y, 200M, 200C, and 200K and an approach/separation mechanisms 300Y, 300M, 300C, and 300K. Note that as previously described, where there is no need to distinguish, the subscripts “Y”, “M”, “C”, and “K” are omitted for each member of the image forming apparatus 110.

The controller 10 controls voltage to be applied to each of the cleaning members 482 by controlling each of the voltage applicators 200.

The belt cleaning section 70 collects toner moved to the transfer belt 66 from the image bearing member 100 in the cleaning mode. The belt cleaning section 70 includes a belt cleaning roller 72, a collected toner container 74, and a backup roller 76. The belt cleaning section 70 is provided below the transfer belt 66. The belt cleaning roller 72 is in contact with the surface (e.g., the outer circumferential surface) of the transfer belt 66. The backup roller 76 is placed to pinch the transfer belt 66 between the backup roller 76 and the belt cleaning roller 72. The belt cleaning roller 72 polishes the surface (i.e., outer circumferential surface being a contact surface) of the transfer belt 66 to collect toner attached to the surface of the transfer belt 66 into the collected toner container 74.

The voltage applicators 200Y, 200M, 200C, and 200K each are connected to a corresponding one of the cleaning members 482Y, 482M, 482C, and 482K. The voltage applicators 200 each apply voltage to a corresponding one of the cleaning members 482.

The approach/separation mechanisms 300Y, 300M, 300C, and 300K bring the development devices 46Y, 46M, 46C, and 46K into contact with and separate them from the image bearing members 100Y, 100M, 100C, and 100K, respectively.

### (Printing Mode)

Control by the controller 10 and operation of the image forming apparatus 110 in the printing mode are described below. Once a print job including image data is input from an external device (not illustrated, a personal computer, for example), the controller 10 executes mode switching to the printing mode. In the printing mode, an image is printed on a sheet P.

Specifically, at a time t11 when printing in the printing mode starts, the controller 10 controls the voltage applicators 200 to apply a first voltage with negative polarity to the cleaning member 482 as depicted in FIG. 4. At time t11, the controller 10 also causes the image bearing members 100, the cleaning members 482, and the transfer belt 66 to start rotating. Toner (positively charged toner) remaining on the image bearing members 100 after transfer is electrostatically collected by the cleaning members 482 to which the first voltage with negative polarity is applied.

In detail, the controller 10 causes application of voltage with positive polarity to the chargers 42 in the printing mode. As a result, the chargers 42 charge the surfaces of the image bearing members 100 to positive polarity. In the above configuration, the positively charged toner is electrostatically moved and collected from the surfaces of the positively charged image bearing members 100 to the cleaning members 482 to which the voltage with negative polarity is applied.

While the cleaning members 482 to which the first voltage with negative polarity is applied continues toner collection, the controller 10 causes, on the rotating image bearing members 100, charging by the chargers 42, light exposure by the light exposure devices 44, development by the development devices 46, transfer by the transfer devices 62, and static elimination by the static eliminators 50. After the unfixed toner images are transferred to the sheet P conveyed between the image bearing members 100 and the transfer devices 62, the controller 10 causes unfixed toner fixing by the fixing section 80, thereby forming an image being a fixed toner image on the sheet P.

At a time when image formation according to all image data contained in the print job is completed, that is, at a time t12 when the printing mode ends, the controller 10 controls the voltage applicators 200 to stop application of the first voltage with negative polarity to the cleaning members 482. At the time t12, the controller 10 also causes the image bearing members 100, the cleaning members 482, and the transfer belt 66 to stop rotating. Thus, the printing mode ends.

As described above, the photosensitive members 1 being the image bearing members 100 are positively charged in a favorable manner even when charging to positive polarity and charging to negative polarity are repeated. As such, in the printing mode, the photosensitive members 1 being the image bearing members 100 are charged to a desired positive potential in a favorable manner in charging even if charging the surfaces of the image bearing members 100 to positive polarity by the chargers 42 and potential decrease to negative polarity in the image bearing members 100 are repeated. Here, the potential decrease is due to contact of the image bearing members 100 with the cleaning members 482 to which the first voltage with negative polarity is applied. As a result, the image forming apparatus 110 including the photosensitive members 1 as the image bearing members 100 can form favorable images even when charging to positive polarity and charging to negative polarity are repeated.

### (Cleaning Mode)

Description is made below of control by the controller 10 and operation of the image forming apparatus 110 in the cleaning mode. Once the printing mode ends, the controller 10 executes mode switching to the cleaning mode. In the cleaning mode after the printing mode ends, toner attached to the cleaning members 482 is collected.

Specifically, during a first predetermined time period T1 (from time t12 to time t13) in the cleaning mode, the controller 10 controls the approach/separation mechanisms 300 to separate the development devices 46 from the image bearing members 100 in a separation direction D1. The separation direction D1 is a direction in which the development devices 46 move away from the image bearing members 100.

After separation of the development devices 46, the controller 10 controls the voltage applicators 200 to apply a second voltage with positive polarity (voltage with the same polarity as the polarity of the charged toner) to the cleaning members 482 at a time t13 in the cleaning mode. At the time t13, the controller 10 also causes the image bearing members 100, the cleaning members 482, and the transfer belt 66 to start rotating. Thus, toner (positively charged toner) attached to the cleaning members 482 is electrostatically moved to the image bearing members 100 from the cleaning members 482 to which the second voltage with positive polarity is applied. The toner moved to the image bearing members 100 moves to the transfer belt 66 through rotation of the image bearing members 100. The toner moved to the transfer belt 66 is collected by the belt cleaning section 70 through rotation of the transfer belt 66.

At a second predetermined time period T2 (from t13 to t14) in the cleaning mode, the second voltage with positive polarity is applied to the cleaning members 482. At a time t14 thereafter, the controller 10 controls the voltage applicators 200 to stop applying the second voltage with positive polarity to the cleaning members 482.

Note that during the second predetermined time period T2 (from t13 to t14) in the cleaning mode, the controller 10 may not cause voltage application to the chargers 42 or cause application of voltage with positive polarity the chargers 42. In application of voltage with positive polarity by the chargers 42, the voltage with positive polarity applied by the chargers 42 is preferably lower than the second voltage with positive polarity applied to the cleaning members 482. This is aimed at electrostatically moving the positively charged toner from the cleaning members 482 to the chargers 42 in a favorable manner.

During a third predetermined time period T3 (from t14 to t15) in the cleaning mode, the controller 10 controls the image bearing members 100, the cleaning members 482, and the transfer belt 66 to continue rotating. During the third predetermined time period T3, the controller 10 also controls the approach/separation mechanisms 300 to move the development devices 46 in an approach direction D2. The approach direction D2 is a direction in which the development devices 46 approach the image bearing members 100. Then at a time t15, the controller 10 causes the development devices 46 to come in contact with the image bearing members 100. At the time t15, the controller 10 also controls the image bearing members 100, the cleaning members 482, and the transfer belt 66 to stop rotating. Note that the time t15 may be a time when a time period elapses. Here, the time period refers to a time period from a time when the toner moved from the cleaning members 482 to the image bearing members 100 directly before stop of application of the second voltage with positive polarity moves from the image bearing members 100 to the transfer belt 66 to a time when the toner is collected into the belt cleaning section 70 from the transfer belt 66. When the image bearing members 100, the cleaning members 482, and the transfer belt 66 stop rotating, the cleaning mode ends.

As described above, the photosensitive members 1 being the image bearing members 100 are positively charged in a favorable manner even when charging to positive polarity and charging to negative polarity are repeated. The image bearing members 100 such as above are less affected by fluctuations in surface potential. Therefore, the image bearing member 100 can be favorably charged to a desired potential with positive polarity when returning to the printing mode after the cleaning mode ends, even when the potential of the photosensitive members 1 is increased to positive polarity by contact with the cleaning members 482 to which the second voltage with positive polarity is applied.

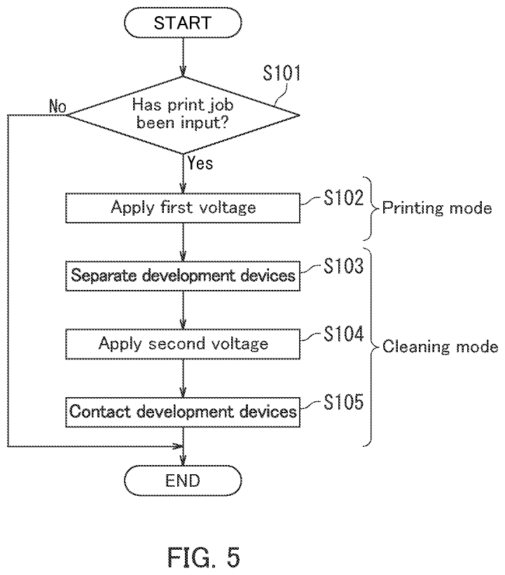

The control by the controller 10 and the operation of the image forming apparatus 110 in the printing mode and the cleaning mode have been described so far. The control by the controller 10 in the printing mode and the cleaning mode are described further in detail below with reference to FIG. 5. FIG. 5 is a flowchart depicting the control of the image forming apparatus 110 illustrated in FIG. 2.

The controller 10 repetitively executes the processing depicted in the flowchart of FIG. 5. Specifically, the controller 10 determines whether or not a print jog has been input (S101). If the print job has not been input (No in S101), the processing in the flowchart depicted in FIG. 5 ends. If the print job has been input (Yes in S101), processing in the printing mode is executed. In the printing mode, the controller 10 controls the voltage applicators 200 to apply the first voltage with negative polarity to the cleaning members 482 (S102). At that time, positively charged toner remaining on the image bearing members 100 is collected by the cleaning members 482 to which the first voltage with negative polarity is applied as described previously.

After the printing mode ends, the cleaning mode is set. In the cleaning mode, the controller 10 causes the development devices 46 to separate from the image bearing members 100 (S103). Next, the controller 10 controls the voltage applicators 200 to apply the second voltage with positive polarity to the cleaning members 482 (S104). At that time, positively charged toner attached to the cleaning members 482 moves to the image bearing members 100 as described previously. Next, the toner moved to the image bearing members 100 is collected into the belt cleaning section 70 via the transfer belt 66. Next, the controller 10 returns the development devices 46 to their original positions to cause the development devices 46 to come in contact with the image bearing members 100 (S105). The controller 10 then ends the processing depicted in the flowchart of FIG. 5.

### (Variation)

Note that the previously described image forming apparatus 110 may be altered as in the following variations. In a multicolor printing mode in which an image in multiple colors is printed, processing in the printing mode and the cleaning mode, which are previously described, are executed.

By contrast, unlike the aforementioned multicolor printing mode, processing in a monochrome printing mode in which a monochrome image is printed can be executed in the following manner. In the monochrome printing mode (during a time period from the time t11 to the time t12 in FIG. 4), the controller 10 controls the voltage applicator 200K (voltage applicator for black color) to apply the first voltage with negative polarity to the cleaning member 482K (cleaning member for black color). During the monochrome printing mode (during the time period from the time t11 to the time t12 in FIG. 4), the controller 10 controls the voltage applicators 200Y, 200M, and 200C (voltage applicators for yellow color, magenta color, and cyan color) to respectively apply a third voltage with positive polarity to the cleaning members 482Y, 482M, and 482C (cleaning members for yellow color, magenta color, and cyan color). Negatively charged minute components (e.g., paper dust) of the sheet P may attach to the image bearing members 100Y, 100M, and 100C (image bearing members for yellow color, magenta color, and cyan color) that are not used in the monochrome printing mode. In view of the foregoing, the third voltage (voltage with positive polarity) is applied to the cleaning members 482Y, 482M, and 482C, thereby electrostatically collecting the negatively charged minute components of the sheet P by the cleaning members 482Y, 482M, and 482C, respectively.

During the second predetermined time period T2 (from the time t13 to the time t14 in FIG. 4) in the cleaning mode after the monochrome printing mode, the controller 10 controls the voltage applicator 200K to apply the second voltage with positive polarity to the cleaning member 482K. This moves positively charged toner attached to the cleaning member 482K onto the image bearing member 100K (image bearing member for black color). During the second predetermined time period T2 (from the time t13 to the time t14 in FIG. 4) in the cleaning mode after the monochrome printing mode, the controller 10 controls the voltage applicators 200Y, 200M, and 200C to apply a fourth voltage with negative polarity to the cleaning members 482Y, 482M, and 482C, respectively. This moves minute negatively charged components of the sheet P attached to the cleaning members 482Y, 482M, and 482C onto the image bearing members 100Y, 100M, and 100C, respectively. Next, the toner moved to the image bearing member 100K and the minute components of the sheet P moved to the image bearing members 100Y, 100M, and 100C are collected into the belt cleaning section 70 via the transfer belt 66. A variation of the present embodiment has been described so far.

One example of the image forming apparatus of the present disclosure has been described so far. However, the image forming apparatus of the present embodiment is not limited to the image forming apparatus 110 and can be altered in the following manners, for example. The image forming apparatus 110 is a color image forming apparatus. However, the image forming apparatus of the present embodiment may be a monochrome image forming apparatus. In this case, the image forming apparatus of the present embodiment need only include one image forming unit, for example. The image forming apparatus 110 is a tandem image forming apparatus. However, the image forming apparatus of the present embodiment may be a rotary image forming apparatus. Scorotron chargers have been exemplified for describing the chargers 42. However, the chargers may each be a charger (e.g., a charging roller, a charging brush, or a corotron charger) other than the scorotron charger. The image forming apparatus 110 adopts the contact development process but may adopt a non-contact development process. The image forming apparatus 110 adopts the direct transfer process but may adopt an intermediate transfer process. The image forming apparatus 110 is switched between the printing mode and the cleaning mode. However, it is only necessary to set the image forming apparatus of the present embodiment to at least the printing mode, and switching to the cleaning mode may not be required. In other words, the configuration in which “the controller 10 causes application of the second voltage with positive polarity to the cleaning members in the cleaning mode” is an optional configuration of the image forming apparatus of the present embodiment. The image forming apparatus of the present embodiment has been described so far.

### [Substituents]

The substituents used in the present specification are described below. Examples of the halogen atom (halogen group) include a fluorine atom (fluoro group), a chlorine atom (chloro group), a bromine atom (bromo group), and an iodine atom (iodo group).

The alkyl groups each are an unsubstituted straight chain or branched chain alkyl group unless otherwise stated. Examples of the alkyl group with a carbon number of at least 1 and no greater than 8 include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ethylpropyl group, a 2-ethylpropyl group, a 1,1-dimethylpropyl group, a 1,2-dimethylpropyl group, a 2,2-dimethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1,1,2-trimethylpropyl group, a 1,2,2-trimethylpropyl group, a 1-ethylbutyl group, a 2-ethylbutyl group, a 3-ethylbutyl group, a straight chain or branched chain heptyl group, and a straight chain or branched chain octyl group. Examples of the other alkyl groups with different carbon numbers include those with corresponding carbon numbers among the above alkyl groups.

The alkoxy groups each are an unsubstituted straight chain or branched chain alkoxy group unless otherwise stated. Examples of the alkoxy group with a carbon number of at least 1 and no greater than 6 include a methoxy group, an ethoxy group, an n-propoxy group, an isopropoxy group, an n-butoxy group, a sec-butoxy group, a tert-butoxy group, an n-pentoxy group, a 1-methylbutoxy group, a 2-methylbutoxy group, a 3-methylbutoxy group, a 1-ethylpropoxy group, a 2-ethylpropoxy group, a 1,1-dimethylpropoxy group, a 1,2-dimethylpropoxy group, a 2,2-dimethylpropoxy group, an n-hexyloxy group, a 1-methylpentyloxy group, a 2-methylpentyloxy group, a 3-methylpentyloxy group, a 4-methylpentyloxy group, a 1,1-dimethylbutoxy group, a 1,2-dimethylbutoxy group, a 1,3-dimethylbutoxy group, a 2,2-dimethylbutoxy group, a 2,3-dimethylbutoxy group, a 3,3-dimethylbutoxy group, a 1,1,2-trimethylpropoxy group, a 1,2,2-trimethylpropoxy group, a 1-ethylbutoxy group, a 2-ethylbutoxy group, and a 3-ethylbutoxy group. Examples of the other alkoxy groups with different carbon numbers include those with corresponding carbon numbers among the above alkoxy groups.

The aryl groups each are an unsubstituted aryl group unless otherwise stated. Examples of the aryl group with a carbon number of at least 6 and no greater than 14 include a phenyl group, a naphthyl group, an indacenyl group, a biphenylenyl group, an acenaphthylenyl group, an anthryl group, and a phenanthryl group. Examples of the other aryl groups with different carbon numbers include those with corresponding carbon numbers among the above aryl groups.

The alkenyl group is an unsubstituted straight chain or branched chain alkenyl group unless otherwise stated. The alkenyl group with a carbon number of at least 2 and no greater than 6 has at least 1 and no greater than 3 double bonds. Examples of the alkenyl group with a carbon number of at least 2 and no greater than 6 include an ethenyl group, a propenyl group, a butenyl group, a butadienyl group, a pentenyl group, a hexenyl group, a hexadienyl group, and a hexatrinyl group. The substituents used in the present specification have been described so far.

### Examples

The following describes the present disclosure further in detail using examples. However, the present disclosure is not limited to the scope of the examples.

### [Inorganic Particles]

Inorganic particles (T1) to (T7) shown below in Table 3 were prepared. The inorganic particles (T1) to (T7) each were the specific inorganic particles. Note that the column titled “Surface treatment layers” in Table 3 indicates component(s) contained in the surface treatment layers of corresponding inorganic particles. For example, “Silica+Alumina” in the column titled “Surface treatment layers” for the inorganic particles (T1) means that the surface treatment layers contain silica and alumina. “MHPS” refers to methylhydrogenpolysiloxane. “Diameter” refers to number average primary particle diameter.

TABLE 3

| | | | | | Diameter |
|---|---|---|---|---|---|
| | Manufacturer | Tradename | Metal oxide particles | Surface treatment layers | [nm] |
| T1 | TAYCA CORPORATION | MT-05 | Titanium oxide particles | Silica + Alumina | 10 |
| T2 | ISHIHARA SANGYO KAISHA, LTD. | TTO-55(A) | Titanium oxide particles | Alumina | 40 |
| T3 | TAYCA CORPORATION | MT-100HD | Titanium oxide particles | Alumina + Zirconia | 30 |
| T4 | TAYCA CORPORATION | MZY-303S | Zinc oxide particles | Silicone oil | 35 |
| T5 | TAYCA CORPORATION | MTY-700BS | Titanium oxide particles | Silicone oil | 80 |
| T6 | TAYCA CORPORATION | MTY-500SAS | Titanium oxide particles | Alumina + Silica + MHPS | 35 |
| T7 | TAYCA CORPORATION | MT-100Z | Titanium oxide particles | Alumina + Stearic acid | 15 |

### [Polyamide Resins]

Polyamide resins (A1) to (A6) formed with the monomers shown below in Table 4 were prepared as described below. Note that the polyamide resins (A1) to (A4) each were the specific polyamide resin among the polyamide resins (A1) to (A6).

### (Polyamide Resin (A1))

A four-necked flask equipped with a stirrer, a thermometer, a nitrogen inlet tube and a dewatering conduit was used as a reaction vessel. Into the reaction vessel, dodecanedioic acid (0.5 parts by mole) as a dicarboxylic acid and isophoronediamine (0.5 parts by mole) as a diamine were charged. Next, the inside of the reaction vessel was purged with nitrogen while stirring the contents of the reaction vessel. Thereafter, the above state was maintained until the end of the reaction. Next, the temperature of the contents of the reaction vessel was heated to 230° C. and the contents of the reaction vessel were allowed to react (dehydration condensation) for 4 hours at that temperature. After the end of the reaction, the internal pressure of the reaction vessel was reduced and the temperature thereof is kept at 250° C. for 2 hours in order to dehydrate water produced by the reaction. Thereafter, the inside of the reaction vessel was returned to the normal temperature and the normal pressure. Thus, the polyamide resin (A1) was obtained.

### (Polyamide Resins (A2) to (A5))

The polyamide resins (A2) to (A5) were prepared according to the same method as that for preparing the polyamide resin (A1) in all aspects other than that the monomers used were changed to those shown below in Table 4. Note that “MM” below in Table 4 refers to 4,4-methylenebis-2-methylcyclohexylamine.

### (Polyamide Resin (A6))

“AMILAN (registered Japanese trademark) CM8000” produced by Toray Industries, Inc. was prepared as the polyamide resin (A6). The polyamide resin (A6) was a copolymer of nylon 6, nylon 12, nylon 66, and nylon 610. The polyamide resin (A6) had a total percentage content of the first repeating unit derived from an aliphatic dicarboxylic acid and the second repeating unit derived from a diamine compound of less than 80% by mole.

TABLE 4

| | Dicarboxylic acid | | | Diamine | | Other | |
|---|---|---|---|---|---|---|---|
| | Type | Carbon number | % by mole | Type | % by mole | Type | % by mole |
| A1 | Dodecanedioic acid | 12 | 50 | Isophoronediamine | 50 | — | — |
| A2 | Decanedioic acid | 10 | 50 | Isophoronediamine | 50 | — | — |
| A3 | Octanedioic acid | 8 | 50 | Isophoronediamine | 50 | — | — |
| A4 | Dodecanedioic acid | 12 | 50 | MM | 50 | — | — |
| A5 | Hexanedioic acid | 6 | 35 | Diaminohexane | 35 | Caprolactam | 30 |

| | |
|---|---|
| A6 | Nylon copolymer |

### <Photosensitive Member Production>

Photosensitive members (P-1) to (P-33) of Test Examples 1 to 30 and Comparative Test Examples 1 to 3 each being a positively chargeable single-layer photosensitive member were produced by the following methods.

### [Photosensitive Member (P-1)]

### (Intermediate Layer Formation)

First, 3 parts by mass of the inorganic particle (T1), 1 part by mass of the polyamide resin (A1), 12 parts by mass of ethanol, 4 parts by mass of n-butanol, and 4 parts by mass of toluene were mixed. The resulting mixture was stirred for 10 hours using a bead mill to sufficiently disperse the inorganic particles (T1) in a solvent (mixed organic solvent of ethanol, n-butanol, and toluene). Through the above, an application liquid for intermediate layer formation was prepared.

An aluminum drum-shaped support (diameter 30 mm, length 252.6 mm) was used as a conductive substrate. The aforementioned application liquid for intermediate layer formation was applied onto the conductive substrate by dip coating. Next, the conductive substrate after the application was dried at 130° C. for 30 minutes. Through the above, an intermediate layer (film thickness: 3 μm) was formed on the conductive substrate.

### (Single-layer Photosensitive Layer Formation)

A mixed liquid was obtained by mixing 3.0 parts by mass of Y-form titanyl phthalocyanine, 70.0 parts by mass of the hole transport material (HTM-1), 45.0 parts by mass of the electron transport material (ETM-1), 100.0 parts by mass of bisphenol Z polycarbonate resin (“PANLITE (registered Japanese trademark) TS2050”, product of TEIJIN LIMITED, viscosity average molecular weight: 50,000) as a binder resin, 0.1 parts by mass of a silicone oil (“KF96-50cs”, product of Shin-Etsu Chemical Co., Ltd., dimethyl silicone oil), and 760.0 parts by mass of tetrahydrofuran. Ultrasonic dispersion treatment was performed on the resulting mixed liquid for 20 minutes using a rod-shaped sonic oscillator to obtain an application liquid for photosensitive layer formation. Next, the application liquid for photosensitive layer formation was applied onto the intermediate layer on the conductive substrate by ring coating. The applied application liquid for photosensitive layer formation was dried at 130° C. for 30 minutes to form a single-layer photosensitive layer (film thickness: 30 μm) on the intermediate layer. Through the above, the photosensitive member of Test Example 1 was obtained.

### [Photosensitive Members (P-2) to (P-33)]

Photosensitive members (P-2) to (P-33) were produced according to the same method as that for producing the photosensitive member (P-1) in all aspects other than the following changes. In the production of the photosensitive members (P-2) to (P-33), the type and amount of inorganic particles added to the application liquid for intermediate layer formation and the type of polyamide resin added thereto were changed to those shown below in Table 5. In addition, in the production of the photosensitive members (P-2) to (P-33), the types of hole transport material and electron transport material added to the application liquid for photosensitive layer formation were changed to those shown below in Table 5.

The terms in Table 5 are as follows.

CGM: charge generating material

CGM-1: Y-form titanyl phthalocyanine

HTM: hole transport material

ETM: electron transport material

Resin 1: bisphenol Z polycarbonate resin (“PANLITE (registered Japanese trademark) TS2050”, product of TEIJIN LIMITED, viscosity average molecular weight: 50,000)

In Table 5 below, “Part” in the column titled “Inorganic particles” means the content [parts by mass] of the inorganic particles relative to 100 parts by mass of the corresponding polyamide resin.

TABLE 5

| | | Intermediate layer | | | Photosensitive layer | | | |
|---|---|---|---|---|---|---|---|---|
| | Photosensitive | Inorganic particles | | Polyamide | | | | Binder |
| | member | Type | Part | resin | CGM | HTM | ETM | resin |
| Test Example 1 | P-1 | T1 | 3 | A1 | CGM-1 | HTM-1 | ETM-1 | Resin 1 |
| Test Example 2 | P-2 | T1 | 3 | A2 | CGM-1 | HTM-1 | ETM-1 | Resin 1 |
| Test Example 3 | P-3 | T1 | 3 | A3 | CGM-1 | HTM-1 | ETM-1 | Resin 1 |
| Test Example 4 | P-4 | T1 | 3 | A4 | CGM-1 | HTM-1 | ETM-1 | Resin 1 |
| Test Example 5 | P-5 | T2 | 3 | A1 | CGM-1 | HTM-1 | ETM-1 | Resin 1 |
| Test Example 6 | P-6 | T3 | 3 | A1 | CGM-1 | HTM-1 | ETM-1 | Resin 1 |
| Test Example 7 | P-7 | T4 | 3 | A1 | CGM-1 | HTM-1 | ETM-1 | Resin 1 |
| Test Example 8 | P-8 | T5 | 3 | A1 | CGM-1 | HTM-1 | ETM-1 | Resin 1 |
| Test Example 9 | P-9 | T6 | 3 | A1 | CGM-1 | HTM-1 | ETM-1 | Resin 1 |
| Test Example 10 | P-10 | T7 | 3 | A1 | CGM-1 | HTM-1 | ETM-1 | Resin 1 |
| Test Example 11 | P-11 | T1 | 3 | A1 | CGM-1 | HTM-2 | ETM-1 | Resin 1 |
| Test Example 12 | P-12 | T1 | 3 | A1 | CGM-1 | HTM-3 | ETM-1 | Resin 1 |
| Test Example 13 | P-13 | T1 | 3 | A1 | CGM-1 | HTM-4 | ETM-1 | Resin 1 |
| Test Example 14 | P-14 | T1 | 3 | A1 | CGM-1 | HTM-5 | ETM-1 | Resin 1 |
| Test Example 15 | P-15 | T1 | 3 | A1 | CGM-1 | HTM-6 | ETM-1 | Resin 1 |
| Test Example 16 | P-16 | T1 | 3 | A1 | CGM-1 | HTM-7 | ETM-1 | Resin 1 |
| Test Example 17 | P-17 | T1 | 3 | A1 | CGM-1 | HTM-8 | ETM-1 | Resin 1 |
| Test Example 18 | P-18 | T1 | 3 | A1 | CGM-1 | HTM-9 | ETM-1 | Resin 1 |
| Test Example 19 | P-19 | T1 | 3 | A1 | CGM-1 | HTM-10 | ETM-1 | Resin 1 |
| Test Example 20 | P-20 | T1 | 3 | A1 | CGM-1 | HTM-11 | ETM-1 | Resin 1 |
| Test Example 21 | P-21 | T1 | 3 | A1 | CGM-1 | HTM-12 | ETM-1 | Resin 1 |
| Test Example 22 | P-22 | T1 | 3 | A1 | CGM-1 | HTM-1 | ETM-2 | Resin 1 |
| Test Example 23 | P-23 | T1 | 3 | A1 | CGM-1 | HTM-1 | ETM-3 | Resin 1 |
| Test Example 24 | P-24 | T1 | 3 | A1 | CGM-1 | HTM-1 | ETM-4 | Resin 1 |
| Test Example 25 | P-25 | T1 | 3 | A1 | CGM-1 | HTM-1 | ETM-5 | Resin 1 |
| Test Example 26 | P-26 | T1 | 3 | A1 | CGM-1 | HTM-1 | ETM-6 | Resin 1 |
| Test Example 27 | P-27 | T1 | 3 | A1 | CGM-1 | HTM-1 | ETM-7 | Resin 1 |
| Test Example 28 | P-28 | T1 | 3 | A1 | CGM-1 | HTM-1 | ETM-8 | Resin 1 |
| Test Example 29 | P-29 | T1 | 1 | A1 | CGM-1 | HTM-1 | ETM-1 | Resin 1 |
| Test Example 30 | P-30 | T1 | 6 | A1 | CGM-1 | HTM-1 | ETM-1 | Resin 1 |
| Comparative Test Example 1 | P-31 | T1 | 3 | A5 | CGM-1 | HTM-1 | ETM-1 | Resin 1 |
| Comparative Test Example 2 | P-32 | T1 | 3 | A6 | CGM-1 | HTM-1 | ETM-1 | Resin 1 |
| Comparative Test Example 3 | P-33 | — | — | A1 | CGM-1 | HTM-1 | ETM-1 | Resin 1 |

### <Single-Layer Photosensitive Member Evaluation>

Charge potential decrease (in detail, amount of decrease in photosensitive member charge potential upon repetition of charging to positive polarity and charging to negative polarity), environmental dependence of sensitivity, and fogging in high-temperature and high-humidity environments were evaluated by the following methods for each of the photosensitive members of Test Examples 1 to 30 and Comparative Test Examples 1 to 3. Evaluation results are shown below in Table 6.

### [Charge Potential Decrease]

The amount of decrease in charge potential of the photosensitive member being a measurement target was measured in an environment (LL environment) at a temperature of 10° C. and a humidity of 15% RH using a drum sensitivity test device (product of GENTEC CO., LTD.). In the measurement, charging to positive polarity and charging to negative polarity of the photosensitive member were repeated so as to reproduce repetition of charging to positive polarity of the photosensitive member by the charger described in the embodiment and charging to negative polarity of the photosensitive member by the cleaning member described in the embodiment.

In detail, the photosensitive member being a measurement target was set in the drum sensitivity test device. The drum sensitivity test device included a first charger, a probe, a second charger, and a static eliminator arrange in the stated order from upstream in the rotation direction of the photosensitive member. The first charger charges the surface of a photosensitive member to the positive polarity (corresponding to charging to positive polarity by the charger described in the embodiment). The first charger was a scorotron charger and had a grid voltage set to +700 V. The probe was provided at a development point to measure the surface potential of a photosensitive member. The second charger is placed at a cleaning point to charge the surface of a photosensitive member to negative polarity (corresponding to charging to negative polarity by the cleaning member described in the embodiment). The second charger was a corotron charger and had an application voltage set to −5 kV. The static eliminator eliminates static on the surface of a photosensitive member (corresponding to static elimination by the static eliminator described in the embodiment).

In a state in which the first charger for charging to positive polarity was turned on, the static eliminator was turned on, and the second charger for charging to negative polarity was turned off, the photosensitive member was turned 10 rotations at a rotational speed of 200 mm/sec. In the manner described above, charging to positive polarity and static elimination of the photosensitive member were repeatedly. During the 10 rotations, the surface potential of the photosensitive member was continuously measured using the probe. The average of the surface potentials of the photosensitive member during the 10 rotations was used as a charge potential V1 (unit: +V) of the photosensitive member before repetition of the charging to positive polarity and the charging to negative polarity.

Next, in a state in which all of the first charger for charging to positive polarity, the static eliminator, and the second charger for charging to negative polarity were turned on, the photosensitive member was turned 200 rotations at a rotational speed of 200 mm/sec. In the manner described above, charging to positive polarity, charging to negative polarity, and static elimination of the photosensitive member were repeated. During the 10 rotations from the 191^{st} rotation to the 200^{th} rotation, the surface potential of the photosensitive member was continuously measured using the probe. The average of the surface potentials of the photosensitive member during the 10 rotations was used as a charge potential V2 (unit: +V) of the photosensitive member after repetition of the charging to positive polarity and the charging to negative polarity.

Thereafter, the amount (unit: V) of decrease in charge potential of the photosensitive member from before to after the repetition of the charging to positive polarity and the charging to negative polarity was calculated using an equation “amount of decrease in charge potential=V1−V2”. The smaller the amount of decrease in charge potential of a photosensitive member, harder it is for the charge potential to decrease with application of cleaning voltage. Therefore, a photosensitive member with a smaller amount of decrease in charge potential is preferable. Charge potential decrease was evaluated according to the following criteria.

### (Criteria of Charge Potential Decrease)

A (good): Amount of decrease in charge potential is less than 150 V.

B (poor): Amount of decrease in charge potential is 150 V or more.

### [Environmental Dependence of Sensitivity]

The sensitivity of the photosensitive member being a measurement target was measured in an environment (LL environment) at a temperature of 10° C. and a humidity of 15% RH using a drum sensitivity test device (product of GENTEC CO., LTD.). In detail, the photosensitive member was charged to have a surface potential of +800 V using the drum sensitivity test device. Next, the surface of the photosensitive member was irradiated with monochrome light (wavelength: 780 nm, optical energy: 0.5 μJ/cm²) taken out of light of a halogen lamp using a bandpass filter. The surface potential of the photosensitive member was measured at a time point when 50 milliseconds elapsed after the monochromatic light irradiation. The measured surface potential was used as a post-exposure potential V_{L} (LL) (unit: +V) in the LL environment. Next, the same measurement was performed as the measurement of the post-exposure potential V_{L} (LL) in the LL environment in all aspects other than that the environment for measurement was changed to an environment (HH environment) at a temperature of 30° C. and a humidity of 80% RH. The measured surface potential was used as a post-exposure potential V_{L} (HH) (unit: +V) in the HH environment. By applying V_{L} (LL) and V_{L} (HH) to the following equation, ΔV_{L} was calculated. The lower the environmental dependence of sensitivity of a photosensitive member, the smaller the value of ΔV_{L}. Environmental dependence of sensitivity of the photosensitive member was evaluated according to the following criteria.

$$Δ {V}_{L} = {V}_{L} ( LL ) - {V}_{L} ( HH )$$

### (Criteria of Environmental Dependence of Sensitivity)

A (good): ΔV_{L} of no greater than 40 (unit: +V)

B (poor): ΔV_{L} of greater than 40 (unit: +V)

### [Fogging in High-Temperature and High-Humidity Environments]

A printer (“ECOSYS (registered Japanese trademark) P2040dw” produced by KYOCERA Document Solutions Japan Inc.) was used as an evaluation apparatus. The evaluation apparatus included a photosensitive member, a charger, a light exposure device, a development device, a transfer device, and a cleaning member. The photosensitive member was removed from the evaluation apparatus and replaced it with the photosensitive member being an evaluation target. The developer standardly supplied with the aforementioned printers was used as an evaluation developer. In an environment (HH environment) at a temperature of 30° C. and a humidity of 80% RH, a gray image was formed on a sheet of printing paper using the evaluation apparatus. The sheet of the printing paper with the gray image formed thereon was visually observed to check for the presence or absence of image defects identified as fog. Fogging in high-temperature and high-humidity environments was evaluated according to the following criteria.

### (Criteria of Fogging in High-Temperature and High-Humidity Environments)

A (good): No fog was observed in sheet of printing paper.

B (poor): Fog was observed in sheet of printing paper.

TABLE 6

| | | | | Environmental dependence of | | |
|---|---|---|---|---|---|---|
| | Photosensitive | Charge potential decrease | | sensitivity | | Fogging |
| | member | V1 − V2 [V] | Rating | Δ V_{L} [+V] | Rating | in HH |
| Test Example 1 | P-1 | 118 | A | 29 | A | A |
| Test Example 2 | P-2 | 120 | A | 27 | A | A |
| Test Example 3 | P-3 | 124 | A | 30 | A | A |
| Test Example 4 | P-4 | 119 | A | 29 | A | A |
| Test Example 5 | P-5 | 120 | A | 30 | A | A |
| Test Example 6 | P-6 | 121 | A | 30 | A | A |
| Test Example 7 | P-7 | 117 | A | 27 | A | A |
| Test Example 8 | P-8 | 118 | A | 31 | A | A |
| Test Example 9 | P-9 | 125 | A | 36 | A | A |
| Test Example 10 | P-10 | 135 | A | 39 | A | A |
| Test Example 11 | P-11 | 118 | A | 30 | A | A |
| Test Example 12 | P-12 | 122 | A | 29 | A | A |
| Test Example 13 | P-13 | 123 | A | 30 | A | A |
| Test Example 14 | P-14 | 125 | A | 32 | A | A |
| Test Example 15 | P-15 | 125 | A | 32 | A | A |
| Test Example 16 | P-16 | 123 | A | 33 | A | A |
| Test Example 17 | P-17 | 121 | A | 31 | A | A |
| Test Example 18 | P-18 | 122 | A | 31 | A | A |
| Test Example 19 | P-19 | 126 | A | 30 | A | A |
| Test Example 20 | P-20 | 127 | A | 30 | A | A |
| Test Example 21 | P-21 | 129 | A | 32 | A | A |
| Test Example 22 | P-22 | 120 | A | 30 | A | A |
| Test Example 23 | P-23 | 89 | A | 31 | A | A |
| Test Example 24 | P-24 | 90 | A | 30 | A | A |
| Test Example 25 | P-25 | 125 | A | 32 | A | A |
| Test Example 26 | P-26 | 120 | A | 30 | A | A |
| Test Example 27 | P-27 | 133 | A | 30 | A | A |
| Test Example 28 | P-28 | 128 | A | 33 | A | A |
| Test Example 29 | P-29 | 131 | A | 35 | A | A |
| Test Example 30 | P-30 | 122 | A | 29 | A | A |
| Comparative Test Example 1 | P-31 | 183 | B | 50 | B | B |
| Comparative Test Example 2 | P-32 | 180 | B | 63 | B | B |
| Comparative Test Example 3 | P-33 | Unmeasurable | B | Unmeasurable | B | B |

As shown in Tables 5 and 6, the photosensitive members (P-1) to (P-30) of Test Examples 1 to 30 included a conductive substrate, an intermediate layer provided on the conductive substrate, and a photosensitive layer provided on the intermediate layer. The intermediate layer contained a specific polyamide resin and specific inorganic particles. The specific inorganic particles included metal oxide particles. The specific polyamide resin included a first repeating unit derived from an aliphatic dicarboxylic acid and a second repeating unit derived from a diamine compound. The total percentage content 10 of the first repeating unit and the second repeating unit was at least 80% by mole to all repeating units included in the specific polyamide resin. The photosensitive members of Test Examples 1 to 30 favorably performed charging to positive polarity even when the charging to positive polarity and the charging to negative polarity were repeated. The photosensitive members of Test Examples 1 to 30 had reduced environmental dependence of sensitivity and inhibited occurrence of fogging in the high-temperature and high-humidity environment.

From the above results, it is thought that as a result of including any of the photosensitive members (P-1) to (P-30) of Test Examples 1 to 30 as an image bearing member, an image forming apparatus including the charger, the light exposure device, the development device, the transfer device, the cleaning member, and the controller described in the embodiment can clean the photosensitive member by electrostatic force, can inhibit charge potential decrease of the photosensitive member, can have reduced environmental dependence of sensitivity in the photosensitive member, and can inhibit occurrence of fogging in high-temperature and high-humidity environments.

By contrast, the photosensitive members (P-31) and (P-32) of Comparative Test Examples 1 and 2 each contained a polyamide resin other than the specific polyamide resin as the polyamide resin of the intermediate layer. The photosensitive members (P-31) and (P-32) are each determined to be highly hygroscopic due to containing no specific polyamide resin in the intermediate layer. The photosensitive members (P-31) and (P-32) were accordingly rated as poor in each evaluation of charge potential decrease, environmental dependence of sensitivity, and fogging in high-temperature and high-humidity environments. That is, it is determined that when using the photosensitive member (P-31) or (P-32), an image forming apparatus including the charger, the light exposure device, the development device, the transfer device, the cleaning member, and the controller described in the embodiment cannot inhibit charge potential decrease of the photosensitive member, cannot inhibit occurrence of fogging in high-temperature and high-humidity environments, and does not have reduced environmental dependence of sensitivity of the photosensitive member.

The photosensitive member (P-33) of Comparative Test Example 3 contained no specific inorganic particles in the intermediate layer. The photosensitive member (P-33), which contained no specific inorganic particles in the intermediate layer, insufficiently exhibited the function of the intermediate layer. Here, the function of the intermediate layer is to inhibit an increase in resistance by allowing electric current generated during photosensitive member exposure to light to smoothly flow. The photosensitive member (P-33) was accordingly rated as poor in each evaluation of charge potential decrease, environmental dependence of sensitivity, and fogging in high-temperature and high-humidity environments (an image at a level suitable for evaluation was not formed). That is, it is determined that when using the photosensitive member (P-33), the image forming apparatus including the charger, the light exposure device, the development device, the transfer device, the cleaning member, and the controller described in the embodiment cannot inhibit charge potential decrease of the photosensitive member, does not have reduced environmental dependence of sensitivity in the photosensitive member, and cannot inhibit occurrence of fogging in high-temperature and high-humidity environments.

What is claimed is:

1. An image forming apparatus comprising:
an image bearing member;
a charger that charges a surface of the image bearing member to positive polarity;
a light exposure device that exposes the charged surface of the image bearing member to light to form an electrostatic latent image on the surface of the image bearing member;
a development device that develops the electrostatic latent image into a toner image;
a transfer device that transfers the toner image from the image bearing member to a transfer target;
a cleaning member that collects toner attached to the surface of the image bearing member by contacting the surface of the image bearing member; and
a controller that controls voltage to be applied to the cleaning member, wherein
the controller causes a first voltage with negative polarity to be applied to the cleaning member in a printing mode,
the image bearing member is an electrophotographic photosensitive member including a conductive substrate, an intermediate layer provided on the conductive substrate, and a photosensitive layer provided on the intermediate layer,
the intermediate layer contains a specific polyamide resin and specific inorganic particles,
the specific inorganic particles include metal oxide particles,
the specific polyamide resin includes a first repeating unit derived from an aliphatic dicarboxylic acid and a second repeating unit derived from a diamine compound, and
a total percentage content of the first repeating unit and the second repeating unit is at least 80% by mole to all repeating units included in the specific polyamide resin.

2. The image forming apparatus according to claim 1, wherein
the metal oxide particles are titanium oxide particles.

3. The image forming apparatus according to claim 1, wherein
the diamine compound has a cycloalkane structure.

4. The image forming apparatus according to claim 1, wherein
the aliphatic dicarboxylic acid has a carbon number of at least 8 and no greater than 20.

5. The image forming apparatus according to claim 1, wherein
the specific inorganic particles include surface treatment layers covering at least parts of surfaces of the metal oxide particles.

6. The image forming apparatus according to claim 5, wherein
the surface treatment layers contain at least one of aluminum oxide, silica, zirconia, stearic acid, and a component derived from an organic siloxane compound.

7. The image forming apparatus according to claim 1, wherein
the controller causes a second voltage with positive polarity to be applied to the cleaning member in a cleaning mode.

8. The image forming apparatus according to claim 1, further comprising
a static eliminator that eliminates static on the surface of the image bearing member.

9. The image forming apparatus according to claim 1, wherein
the photosensitive layer contains a charge generating material, an electron transport material, a binder resin, and a hole transport material.

10. The image forming apparatus according to claim 9, wherein
the charge generating material includes titanyl phthalocyanine having a Y-form crystal structure.

11. The image forming apparatus according to claim 9, wherein
the hole transport material includes at least one of compounds represented by formulas (HTM-1) to (HTM-8) below:

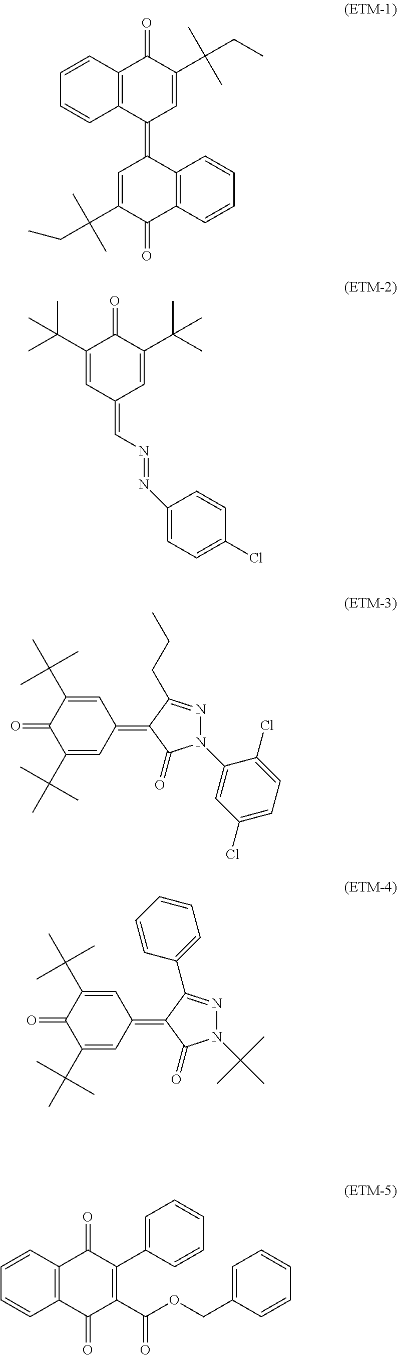

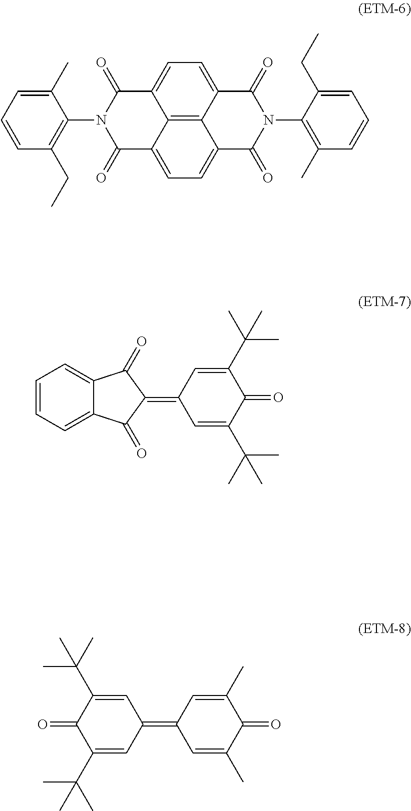 [SMILES: CCc1cccc(C)c1N1C(=O)c2ccc3c4c(ccc(c24)C1=O)C(=O)N(c1c(C)cccc1CC)C3=O ; CC(C)(C)C1=CC(=C2C(=O)c3ccccc3C2=O)C=C(C(C)(C)C)C1=O ; CC1=CC(=C2C=C(C(C)(C)C)C(=O)C(C(C)(C)C)=C2)C=C(C)C1=O]

12. The image forming apparatus according to claim 9, wherein
the hole transport material includes at least one of compounds represented by formulas (HTM-1) to (HTM-12) below:

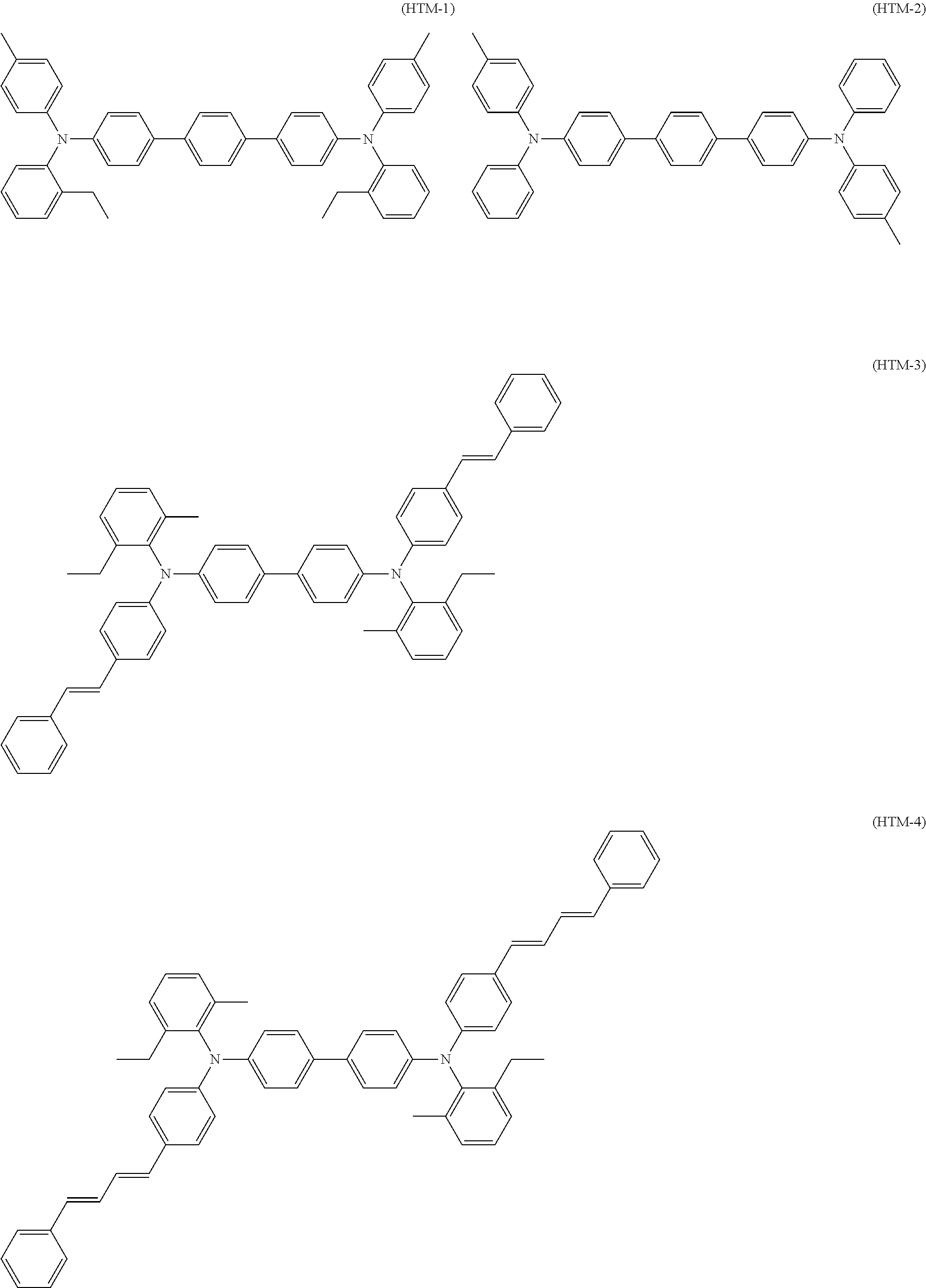

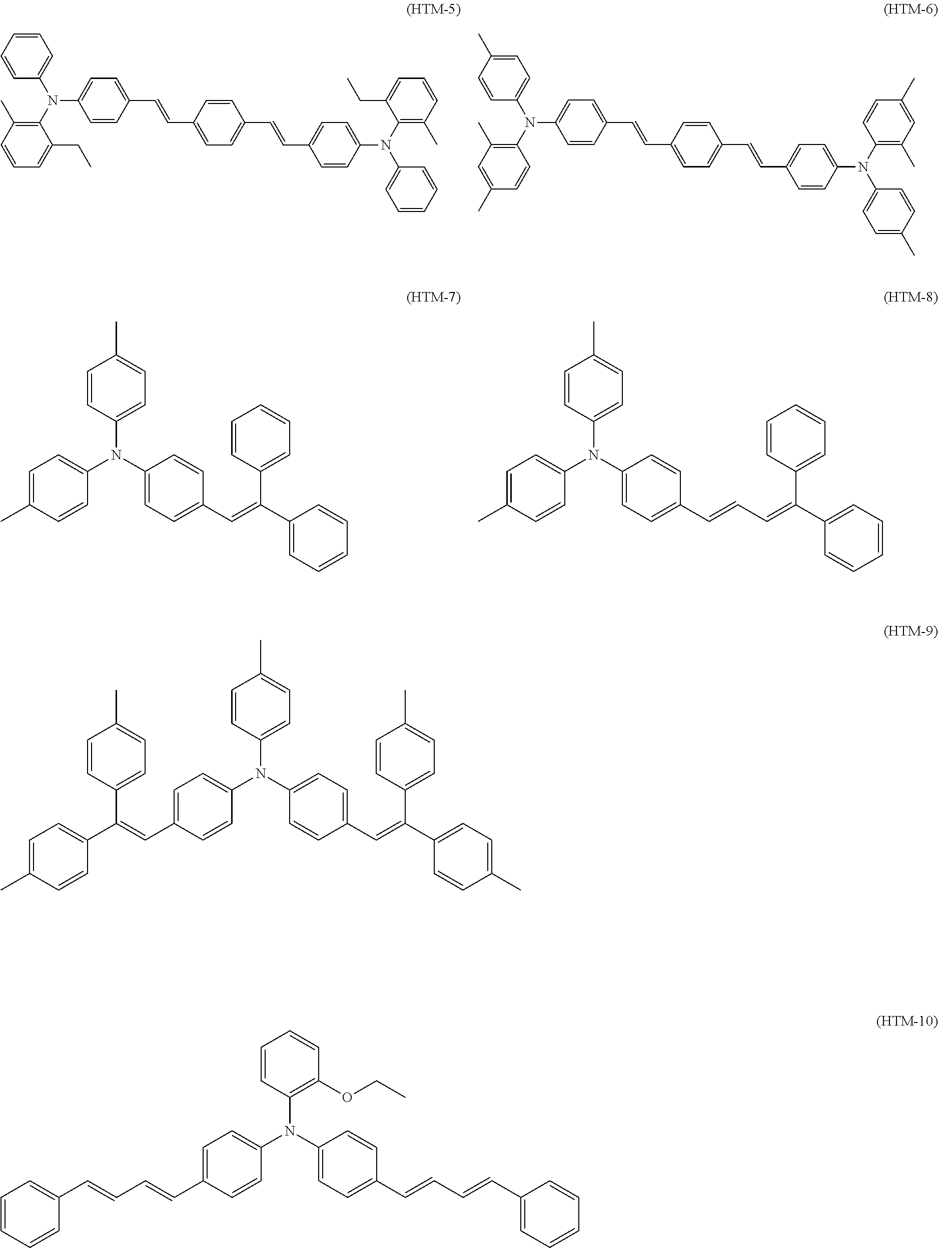

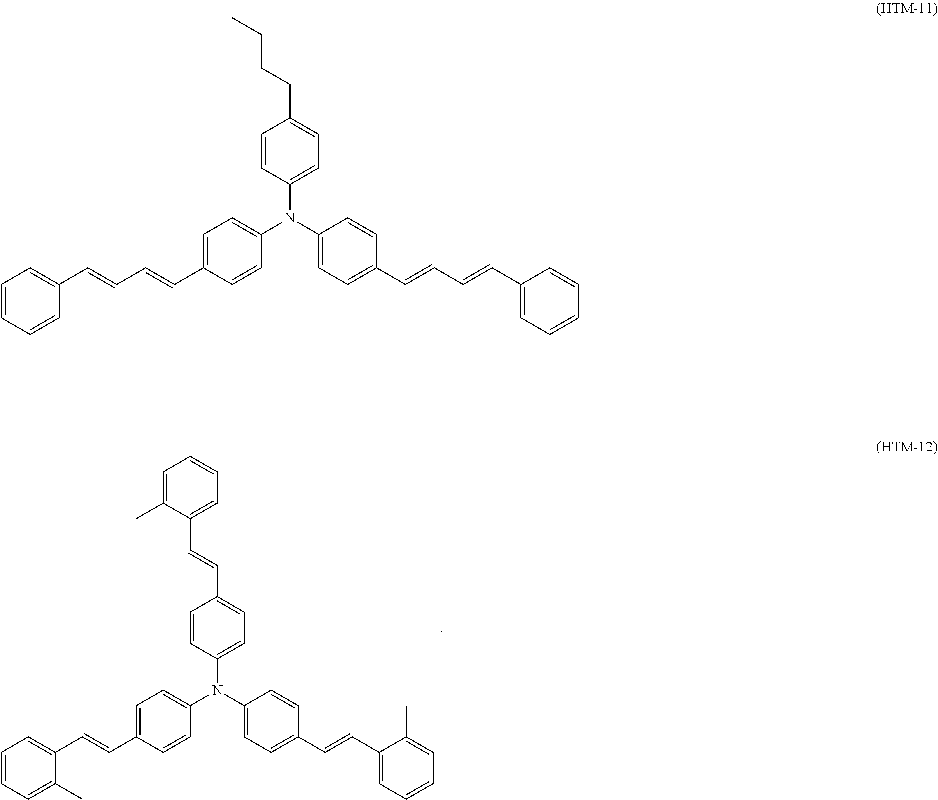 [SMILES: CCCCc1ccc(N(c2ccc(/C=C/C=C/c3ccccc3)cc2)c2ccc(/C=C/C=C/c3ccccc3)cc2)cc1 ; Cc1ccccc1/C=C/c1ccc(N(c2ccc(/C=C/c3ccccc3C)cc2)c2ccc(/C=C/c3ccccc3C)cc2)cc1]

13. The image forming apparatus according to claim 1, wherein
the specific inorganic particles have a content of at least 50 parts by mass and no greater than 1000 parts by mass relative to 100 parts by mass of the specific polyamide resin in the intermediate layer.

14. The image forming apparatus according to claim 1, wherein
the specific inorganic particles have a number average primary particle diameter of at least 5 nm and no greater than 100 nm.
